(19) United States
(12) Patent Application Publication
(10) Pub. No.: US 2026/0064981 A1
(43) Pub. Date: Mar. 5, 2026

(54) PROCESS MODEL MANAGEMENT USING GENERATIVE AI

(71) Applicant: Oracle International Corporation, Redwood Shores, CA (US)

(72) Inventors: Dinesh Balebail, San Jose, CA (US); James Livingston, Austin, TX (US); Donald Wayne Bean, Belmont, CA (US)

(73) Assignee: Oracle International Corporation, Redwood Shores, CA (US)

(21) Appl. No.: 19/076,902

(22) Filed: Mar. 11, 2025

Related U.S. Application Data
(60) Provisional application No. 63/689,315, filed on Aug. 30, 2024.

(51) Int. Cl. G06F 40/40; G06F 40/186; G06F 40/274

(52) U.S. Cl. CPC G06F 40/40; G06F 40/186; G06F 40/274

(57) ABSTRACT

Systems, methods, and computer-readable media are provided for receiving partial text input and providing suggested input text based on example text input associated with one or more prompt templates for prompting an LLM to cause a particular type of application functionality. Systems, methods, and computer-readable media are also provided for selecting a prompt template based on content of text input, and generating a prompt based on the prompt template for prompting an LLM to cause a particular type of application functionality.

### CROSS-REFERENCE TO RELATED APPLICATIONS

This application claims priority to U.S. Provisional Application No. 63/689,315 filed Aug. 30, 2024, the entirety of which is incorporated herein by reference.

### BACKGROUND

Data structures are managed by application systems to accomplish complex data management functionality that involves assigning data items or portions of amounts determined from data items to different entities, and re-calculating amounts to be used for data transformation. The complex data management functionality may be accomplished by various workflows managed by the application systems.

### BRIEF SUMMARY

A computer-implemented method is provided for receiving partial text input and providing type-ahead text based on example text input associated with one or more prompt templates for prompting an LLM to cause a particular type of application functionality. A computer-implemented method is also provided for selecting a prompt template based on content of text input, and generating a prompt based on the prompt template for prompting an LLM to cause a particular type of application functionality.

In one embodiment, a computer-implemented method includes storing a plurality of user input examples in association with one or more prompt templates. The plurality of user input examples include a first user input example comprising a first text portion and a second user input example comprising a second text portion that is different from the first text portion. The computer-implemented method further includes receiving, via a user interface, partial text input from a user. The computer-implemented method further includes determining that the partial text input is a subset of the first text portion, and based at least in part on determining that the partial text input is a subset of the first text portion, displaying an input template for the partial text input. The input template comprises the first user input example with one or more placeholders in place of one or more variables of the first user input example. An incomplete portion of the input template is graphically distinguished from the partial text input. The computer-implemented method further includes receiving completed text input comprising one or more particular variables in place of the one or more placeholders. The computer-implemented method further includes selecting a prompt template associated with the first user input example, and generating a prompt based at least in part on the prompt template. The computer-implemented method further includes prompting a large language model with the prompt. The computer-implemented method further includes receiving a response from the large language model, and causing execution of one or more commands in the response. The execution of the one or more commands modifies one or more data structures based at least in part on the one or more particular variables.

In a further embodiment, the first user input example is in the selected one or more prompt templates and included as an example in the prompt.

In the same or a different further embodiment, the one or more data structures are modified to change a workflow of operations that is executable against a set of data. In a further embodiment, the computer-implemented method includes receiving another user input, generating another prompt comprising the other user input, prompting the large language model with the other prompt, receiving another response from the large language model, and causing execution of the workflow against the set of data based at least in part on the other response.

In one embodiment, a computer-implemented method includes receiving, via a user interface, text input from a user. Based at least in part on content of the text input, the computer-implemented method includes selecting a first prompt template for triggering a first type of application functionality using a first set of one or more command formats. One or more other prompt templates are stored in association with one or more other types of application functionality using one or more other sets of one or more command formats. The computer-implemented method further includes generating a prompt based at least in part on the first prompt template, wherein the first prompt template comprises a plurality of examples of using the first set of one or more command formats to generate structured results. The computer-implemented method further includes prompting a large language model with the prompt, and receiving a particular structured result from the large language model. The computer-implemented method further includes causing display of a predicted outcome of executing, by an application, a particular command of a particular command format from the particular structured result, and causing execution, by the application, of the particular command of the particular command format from the particular structured result. The execution triggers a change to one or more data structures accessible from a user interface of the application.

In a further embodiment, the particular structured result is a JSON object comprising an identified command and one or more parameters of the identified command determined based at least in part on the text input.

In the same or a different further embodiment, the predicted outcome is displayed as a table of data changes that will occur when the application executes the particular command.

In a further embodiment, the change to the one or more data structures changes a workflow of operations that is executable against a set of data. In a further embodiment, the computer-implemented method includes receiving another text input, determining that the other text input is associated with another prompt template, and generating another prompt based at least in part on the other prompt template. The other prompt comprises the other text input. The computer-implemented method further includes prompting the large language model with the other prompt, receiving another response from the large language model, and causing execution of the workflow against the set of data based at least in part on the other response.

In the same or a different further embodiment, the prompt further comprises a context of a user session that identifies one or more objects stored in association with the one or more data structures.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1A illustrates a flow chart of an example process that autocompletes user input based on examples associated with large language model prompts.

FIG. 1B illustrates a flow chart of an example process that manages models using generative AI.

FIG. 2 illustrates a system diagram showing an example computer system that manages models using generative AI.

FIGS. 3-21 illustrate example user interfaces for managing models.

FIG. 22 depicts a simplified diagram of a distributed system for implementing certain aspects.

FIG. 23 is a simplified block diagram of one or more components of a system environment by which services provided by one or more components of an embodiment system may be offered as cloud services, in accordance with certain aspects.

FIG. 24 illustrates an example computer system that may be used to implement certain aspects.

FIGS. 25-27 illustrate an example user interface for managing models with access to example templates.

FIG. 28 illustrates an example agent-based workflow to classify intent, generate prompts, and execute commands.

### DETAILED DESCRIPTION

Systems, methods, and computer-readable media are provided for receiving partial text input and providing type-ahead text based on example text input associated with one or more prompt templates for prompting an LLM to cause a particular type of application functionality. Systems, methods, and computer-readable media are also provided for selecting a prompt template based on content of text input, and generating a prompt based on the prompt template for prompting an LLM to cause a particular type of application functionality.

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Various embodiments are described for using generative artificial intelligence (AI) such as through a large language model to create a waterfall allocation process. A computer system, for example a computer system operating a profitability and cost management agent, creates waterfall model rulesets, with rulesets having rules, based on user input in the form of natural language commands. The system defines a reusable and targeted grouping of allocation rules as a model. The allocation rules can be created and grouped for control of sequence-dependent processing steps. The control of the steps may be accomplished to perform steps in serial or parallel with steps being performed concurrently. The use of generative AI enables process requirements to be reduced to system-specific artifacts using natural language commands to reduce the expertise and time required to manage a process and to operate the process more efficiently and accurately on the computer system.

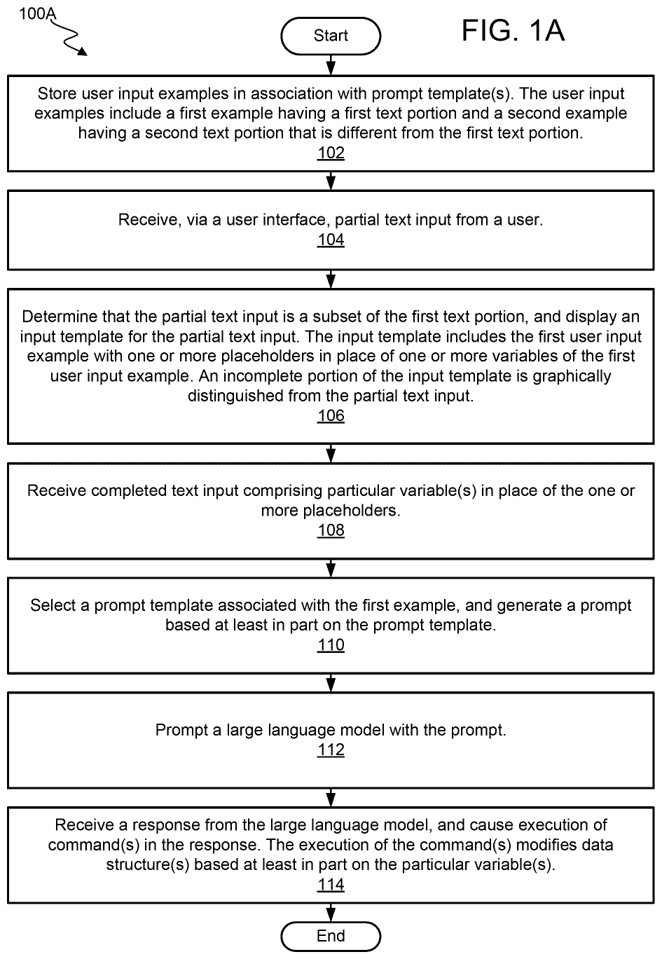

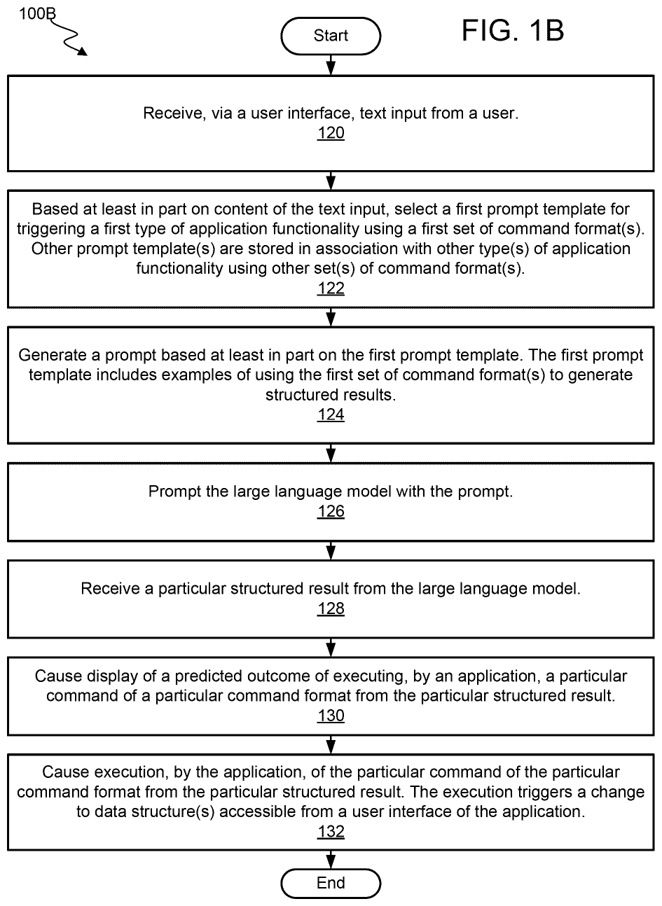

FIG. 1A illustrates a flow chart of an example process 100A that autocompletes user input based on examples associated with large language model prompts. As shown, block 102 includes storing user input examples in association with prompt template(s). The user input examples include a first example having a first text portion and a second example having a second text portion that is different from the first text portion. In block 104, the system receives, via a user interface, partial text input from a user. In block 106, the system determines that the partial text input is a subset of the first text portion, and displays an input template, such as a type-ahead template or other suggestion template, for the partial text input. The type-ahead template is an example of a suggestion template (also called an input template) that represents a user intent for running a command, function, or other action, and the suggestion template may be selected based on previous user input that most closely matches current partial user input for carrying out the action. The previous user input may be transformed into a skeleton or template by stripping away or making generic individualized variable selections to leave a set of command terms that drive functionality with placeholders for command parameters that determine values to use for carrying out the functionality against a data set. The suggestion template may be referred to herein as a “suggestion” that is based on current user input, available commands, and/or past user input.

The input template may include the first user input example with one or more placeholders in place of one or more variables of the first user input example. An incomplete portion of the input template may be graphically distinguished from the partial text input. In block 108, the system receives completed text input comprising particular variable(s) in place of the one or more placeholders. In block 110, the system selects a prompt template associated with the first example, and generates a prompt based at least in part on the prompt template. The prompt template may be further customized using retrieval augmented generation (“RAG”) to select examples, datasets, or other information to include as relevant to the prompt or to specific content covered by the prompt, for example, by finding datasets that are similar (e.g., with embeddings having a higher cosine similarity than embeddings of other datasets) to the specific content otherwise covered by the prompt. For example, existing examples of inputs, outputs, or pairs of inputs and outputs for a large language model may be selected from an example data store such that the selected examples are most similar to the suggestion template being used. Examples may include good examples of valid inputs and/or outputs, as well as bad examples of invalid inputs and/or outputs, to guide an LLM to produce valid output based on valid input. The existing examples may guide a large language model to produce valid output that operates using existing commands within an existing data schema even if the specific combination of commands and parameters has never before been attempted. In block 112, the system prompts a large language model with the prompt. In block 114, the system receives a response from the large language model, and cause execution of command(s) in the response. The execution of the command(s) modifies data structure(s) based at least in part on the particular variable(s).

In one embodiment, the input template is a type-ahead template that uses examples to fill in not just suggested structures of commands as the user types in the input but navigates through suggested variables to determine which variables are compatible with and/or most often used with variables already provided in the input, such that command structure and variable values change as the user continues to type in partial command and variable input. The changes may be driven by a decision tree that determines which inputs (commands and variables) are most often used together after different break points in partial commands and/or which corresponding portions of the user datasets are most relevant or most similar to the input provided. In one example, input referencing a command with few parameters provided may be continued to be typed ahead by the system as the simple version of the command without adding options for other less frequently provided parameters. As another example, input referencing a command with all or most parameters specified may be continued to be typed ahead by the system as the robust version of the command with all or most options for less frequently provided parameters in light of the pattern detected so far in typing the input. As another example, input referring to a particular dimension or other particular data value may be typed ahead by the system to refer to existing members of the particular dimension or other data compatible with the particular data value, based on the underlying data accessible to the user. Different permutations of commands and/or parameter values may be scored based on their frequency of use and suggested in the type-ahead interface or another suggestion interface based on the frequency of use.

In one embodiment, the input template is a speak-ahead template that uses examples to fill in not just suggested structures of commands as the user speaks in the input but navigates through suggested variables to determine which variables are compatible with and/or most often used with variables already provided in the input, such that the command structure and variable values change as the user continues to speak in partial command and variable input.

FIG. 1B illustrates a flow chart of an example process 100B that manages models using generative AI. As shown, block 120 includes receiving, via a user interface, text input from a user. In block 122, based at least in part on content of the text input, the system selects a first prompt template for triggering a first type of application functionality using a first set of command format(s). Other prompt template(s) are stored in association with other type(s) of application functionality using other set(s) of command format(s). In block 124, the system generates a prompt based at least in part on the first prompt template. The first prompt template includes examples of using the first set of command format(s) to generate structured results. In block 126, the system prompts the large language model with the prompt, and the system receives a particular structured result from the large language model in block 128. In block 130, the system causes display of a predicted outcome of executing, by an application, a particular command of a particular command format from the particular structured result. In block 132, the system causes execution, by the application, of the particular command of the particular command format from the particular structured result. The execution triggers a change to data structure(s) accessible from a user interface of the application.

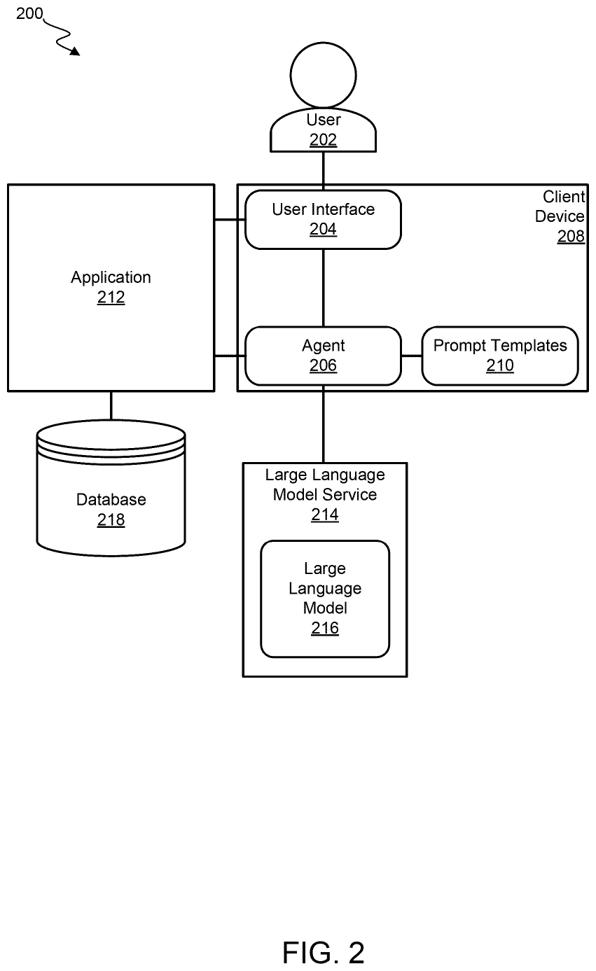

FIG. 2 illustrates a system diagram showing an example computer system 200 that manages models using generative AI. As shown, user 202 interacts with client device 208 via user interface 204, such as in a browser or installed application. User 202 may submit text input via user interface 204. Agent 206 may match the text input to a prompt template from prompt templates 210, fill in the prompt, and submit the prompt to large language model 216 via large language model service 214. The result may be returned to the agent, which may submit command(s) to the application 212 for updating data structures stored in database 218 and/or updating data displayed on user interface 204.

In various embodiments, agent 206 may be configured to use tools as an authenticated user to retrieve information relevant to the prompt, for example, using APIs exposed by the tools and authenticating with the APIs using security tokens or other authentication mechanisms. Agent 206 may additionally or alternatively be configured to use RAG to supplement the prompt with relevant information from a data store. Agent 206 may be configured with heuristics or other logic to take different processing pathways depending on results retrieved from tools or RAG, some pathways resulting in additional information retrieval or validation or more or fewer round-trips of prompts to the large language model 216 via large language model service 214.

Agent 206 may be one of many autonomous agents configured to communicate with large language model service 214 and/or tools or data stores to support command creation and/or execution. A supervising agent may communicate with worker agents specialized to trigger different types of functionality, and the supervising agent may autonomously determine which worker agent to use depending on input received. For example, the supervising agent may interpret input to determine individual steps requested from the input, and the supervising agent may determine which worker agent to use to carry out different steps of the individual steps before assembling results. The different worker agents may have access to different tools and/or data stores and may have different scores or levels of positive or negative feedback for different types of input. The supervising agent may take into account past performance of the worker agents for different users and different historical inputs to determine which worker agent(s) to use in which scenarios for which user(s), and, in some embodiments, the supervising agent may use different worker agents in parallel and combine results from the different worker agents and/or use the different results to determine an aggregated, summarized, average, or most frequently occurring result that is determined to best address the user input. The supervising agent may also interact with validation agents that are trained to validate and/or summarize commands generated by other worker agents prior to executing the commands.

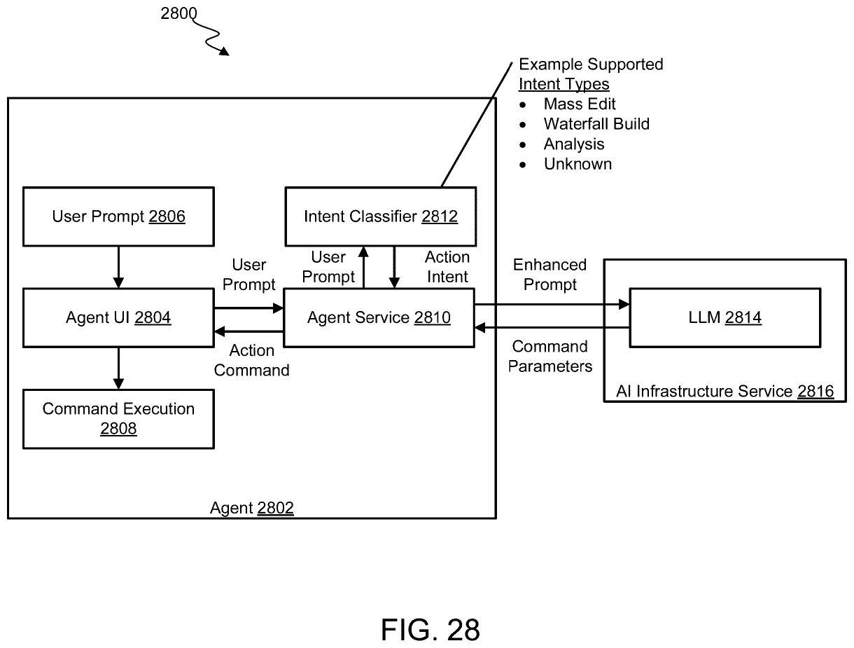

FIG. 28 illustrates an example agent-based workflow to classify intent, generate prompts, and execute commands. In the example, a user interacts with a client device to provide user prompt 2806 to agent UI 2804 of agent 2802. Agent 2802 passes the user prompt to intent classifier 2812 to determine which intent type of example intent types the prompt relates. The selected intent type is used to enhance a prompt to an LLM by agent service 2810. Agent service 2810 submits the prompt to large language model 2814 of AI infrastructure service 2816. The result may be returned to the agent 2802, which may submit action command(s) to an application for execution as command execution 2808, for example, to update data structures stored in a database and/or update data displayed on a user interface.

### Multi-Dimensional Data Management

Hierarchical data may be stored as a cube or a collection of dimensions, where each dimension has members arranged in a hierarchy. A “dimension” is a collection of related data items that are organized together and, for example, may share a common data structure, schema subset, or index, and may be related to other dimensions. Dimensions may have one or more attributes or fields that define values, or that define formulas for obtaining values. Non-limiting examples of dimensions may include account, department, business unit, product line, market, division, time, and location, and each dimension may have multiple levels of members or nodes with information. As used herein, the terms “member,” “node,” and “row” are used interchangeably to refer to an individual item of data hierarchically positioned in a structured dataset. Each member may be a child of another member or a root member for the dimension, forming a tree of members for each dimension that can be represented as a drill-down hierarchy of members along each dimension.

Data may be maintained at the lowest levels of the tree structure and rolled up to higher levels. For example, data on the monthly level of time data of Jan, Feb, and Mar may be rolled up to data on the quarterly level of time data, which may be rolled up to data on the annual level of time data. Similarly, data at the city level of a location dimension may be rolled up to data on the state level of the location dimension, which may be rolled up to data at the country level. Other dimensions, such as product information, sales information, and other information, may be linked to the time dimension such that slices of data may be obtained as intersections between the corresponding values for the corresponding dimensions. Dimensions may be linked together using keys or other references that identify specific members of other dimensions associated with a record. Additional details may be pulled from the other dimensions using the key as a reference to the other dimension and drilling down or rolling up in the data structure along the other dimension. For example, information about a particular product having units sold in a given quarter may be determined from an intersection between the product, sales, and time dimensions as a data slice.

A schema or hierarchical structure may be applied to the members, and different dimensions may support different sub-schemas of the database where data fitting within the dimension conforms to a certain data format and has certain well-defined relationships with other data in the dimension. Data fitting within certain parts of the schema or hierarchical structure may feed into or be bound to formulas, workflows, models or other logic managed by an application to use the data to efficiently determine values or accomplish tasks. For example, the weight of all units in a “units produced” portion of the hierarchy may be used in a first formula for determining individual shipping costs for each unit and a second formula for aggregating shipping costs across all units.

In one embodiment, a multidimensional data management application provides access to data for analysis and management. Dimensions that align with existing structures, relationships, and logic in a stored hierarchy of data may have pre-configured structure, relationships, and logical formulas, models, or workflows that use the values provided or statically defined to populate other dynamic nodes that depend on the static values. Uploaded data may fit into a structure expected by existing logic such that the existing logic is automatically updated as the uploaded data is provided. For example, if a dynamic node exists where all children nodes are summed together, and the uploaded data adds or updates a child node of the dynamic node, the dynamic node may be updated automatically to account for the uploaded data.

In one embodiment, a data management application such as Oracle Essbase® provides views of multidimensional data, and the views provide options for modifying or analyzing the multidimensional data according to a data management user interface. In one example, the views are displayed in a Microsoft Excel interface using a Microsoft Excel plug-in to control what data is visible in which cells, whether that data is modifiable, and what database structures of a back-end database are mapped to the cell such that the corresponding cell holds value(s) of the database structures and the database structures get modified when the corresponding cell gets modified.

In another example, the views are displayed in a browser interface that shows a grid of cells where code executed in the browser controls what data is visible in which cells, whether the data is modifiable, and what database structures of a back-end database are mapped to the cell such that the corresponding cell holds value(s) of the database structures and the database structures get modified when the corresponding cell gets modified.

A particular combination of values across different dimensions is shown on the screen as one or more data slices, and the data slice(s) may be filtered or combined with other data slice(s) to change a shape of the dataset being visualized, modified, or analyzed.

### Allocation Waterfall Setup

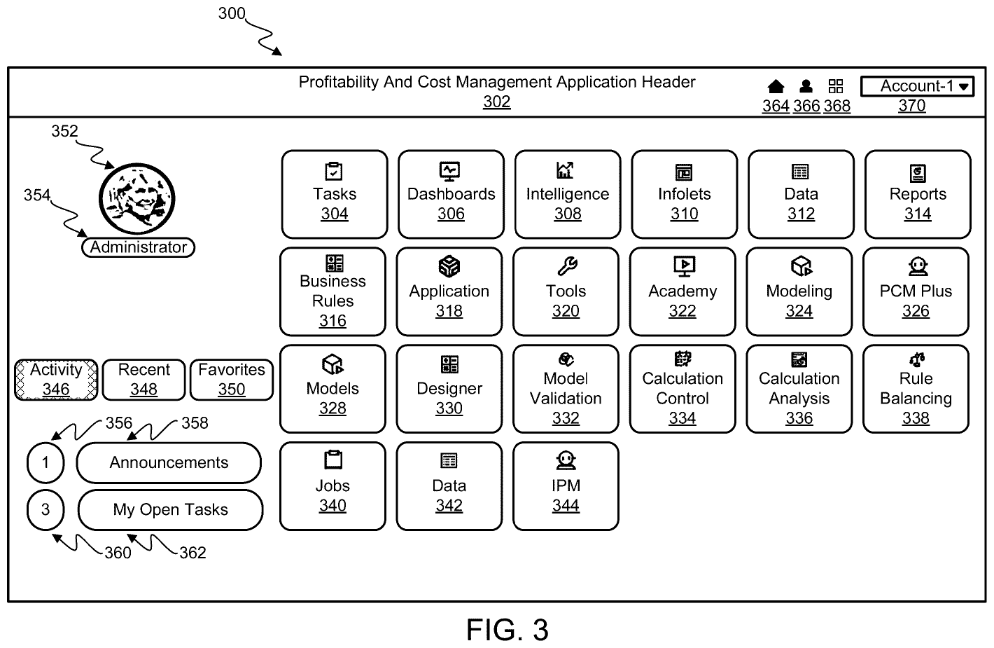

In one example illustrated in FIG. 3, the system, such as an enterprise performance management system, displays a landing page or portal 300 for a user to interact with various aspects of functionality offered by the system. The page may include a profitability and cost management application header 302 and options 364, 366, and 368 to navigate to a home page, to a user profile configuration page, and to adjust the view or navigation of tools within the system. An account identifier 370 may be selectable to change between different accounts for managing different datasets by the same user. As shown, the user has configured a profile including a user image 352 and a user's primary role 354 as an administrator. Landing page 300 also includes options 346, 348, and 350 for viewing activity, recent tasks or items relevant to the user, and/or favorite tasks or items frequently revisited by the user.

Announcements 358 are shown, with an indicator 356 showing a number of announcements available for view. Open tasks 362 are also shown, with an indicator 360 showing a number of open tasks available for view.

The system may use an Oracle Essbase or other multidimensional database cube or other database to store and calculate data. The data and calculated results can be output to analytic tools accessible on the landing page, such as Tasks 304, Dashboards 306, Intelligence 308, Infolets 310, Data 312, Reports 314, Business Rules 316, Application 318, Tools 320, Academy 322, Modeling 324, PCM Plus 326, Models 328, Designer 330, Model Validation 332, Calculation Control 334, Calculation Analysis 336, Rule Balancing 338, Jobs, 340, Data 342, and Intelligent Performance Management (IPM) 344. The modeling option 324 provides users with a guided approach to create an allocation waterfall, and the PCM Plus option 326 or Profitability and Cost Management (PCM) agent option allows users to interact with a tool using natural language to perform operations against the multidimensional data and models, rules, and rulesets of an allocation waterfall.

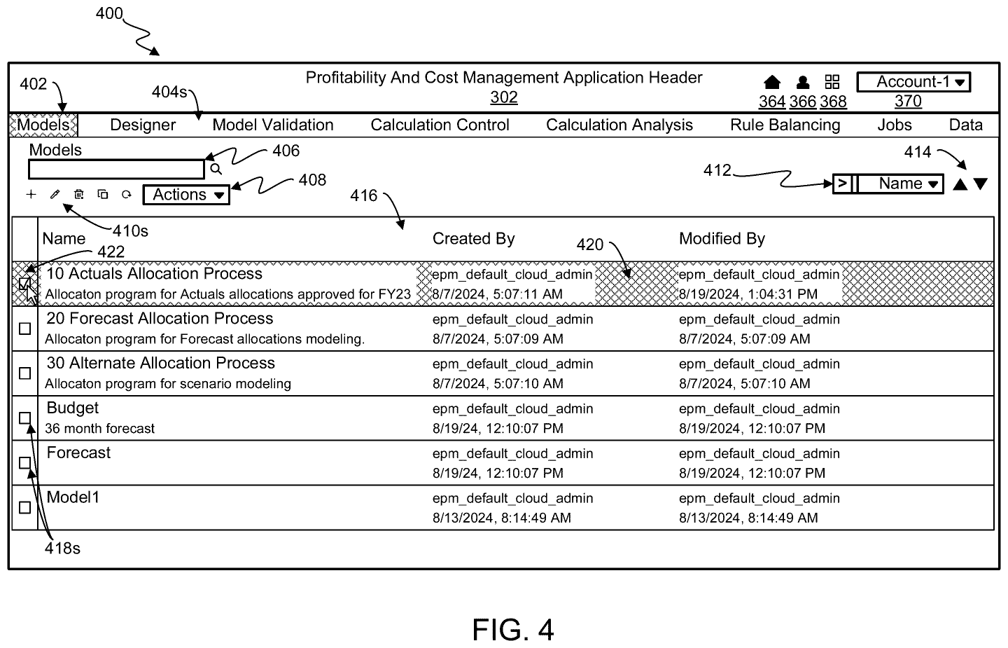

A model is a group of rules and is a single waterfall. There can be many models or waterfalls, which are named collections of rules. A model may be created for a purpose, such as for actuals allocation, forecast allocation, alternate allocation, budgeting, forecasting, etc., as shown by the examples in the user interface illustrated in FIG. 4. FIG. 4 shows a user interface 400 in which a model navigation option 402 has been selected among options 404s. A models view includes a search box 406 to search existing models, and tool icons 410s for performing selected functionality with respect to actions or models. The models 416 are listed and may be sorted using sort tool 412 or 414, for example by name ascending or descending. The models 416 are listed with selection options 418s, which allow selected item 420 to be selected via checkbox 422. The models may be created as a container for the collection of rules. The container may have certain properties, and the rules may be modified once the container is created.

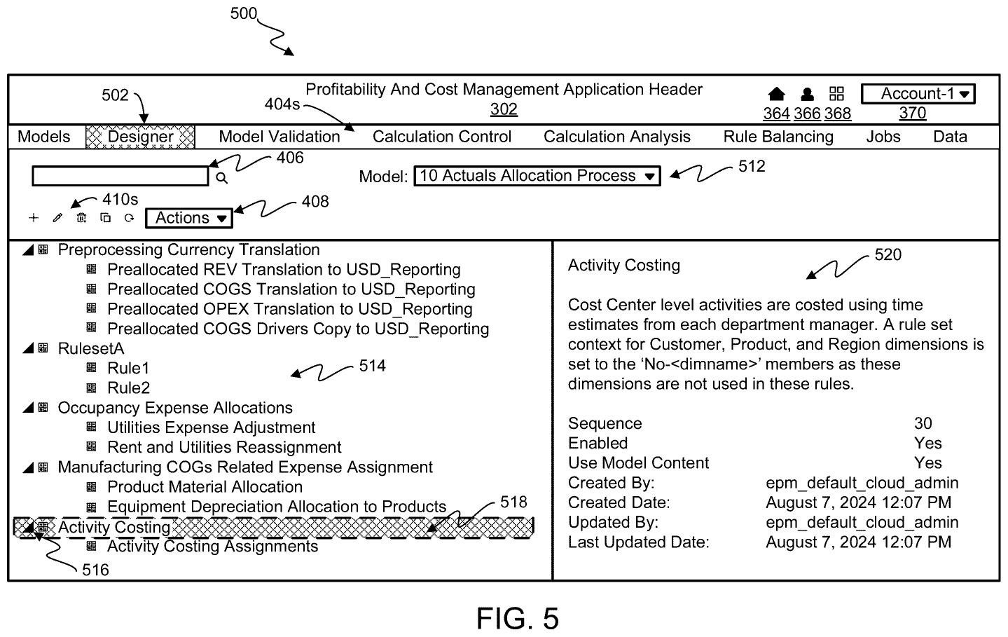

FIG. 5 shows a designer navigation option 502 viewed within user interface 500. In the designer navigation option 502, within a given model, selectable via a selection indicator 512 as shown by the user interface 500 illustrated in FIG. 5, a series of steps 514 are provided to modify a user's existing data and transform the existing data into target data that results from the series of steps 514. Each step 514, such as “Preprocessing Currency Translation,” “RulesetA,” “Occupancy Expense Allocations,” “Manufacturing COGs Related Expense Assignment,” and “Activity Costing,” is referred to as a ruleset that may contain many member rules. The rulesets 514 include rules that are applied sequentially in parallel, as configured, to accomplish the transformation needed according to the stated purpose for the model. These rules may operate on data that is input into the model and/or data that is modified or provided by prior rules. For data that is based on prior rules, sequential dependencies may be preserved within the model. In the example, ruleset “Activity Costing” 516 is selected as indicated by a selection indicator 518, which is a shaded region as shown. Additional information 520 is displayed about the selected ruleset 516.

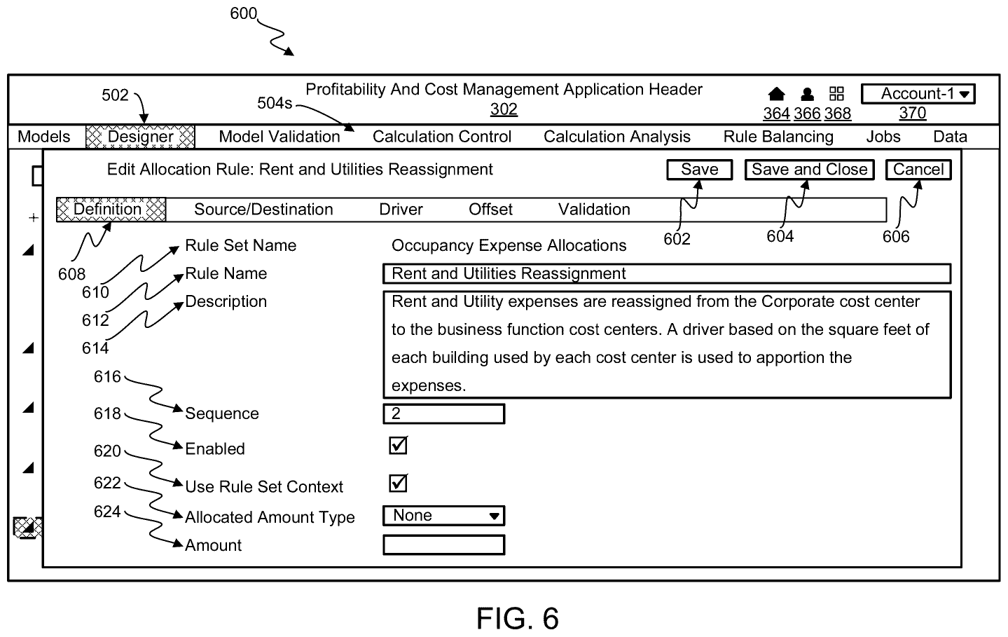

FIG. 6 shows a definition navigation option 608 to edit an allocation rule. The rulesets and rules may be named based on a summary of the included functionality, such as the “Occupancy Expense Allocations” ruleset named in rule set name region 610 that includes the “Rent and Utilities Reassignment” rule named in rule name region 612 as shown in the user interface 600 illustrated in FIG. 6. As shown in the example, for the rule “Rent and Utilities Reassignment,” a description 614 is stored that states: “Rent and Utility expenses are reassigned from the Corporate cost center to the business function cost centers. A driver based on the square feet of each building used by each cost center is used to apportion the expenses.” The rule is defined to have Sequence 2 using sequence specification option 616, which means the rule is executed after rules having Sequence 1. The rule is enabled, as indicated by option 618, and uses the rule set context, as indicated by option 620. The allocated amount type is specified as “None” in allocated amount type option 622, and an amount may be specified in amount region 624.

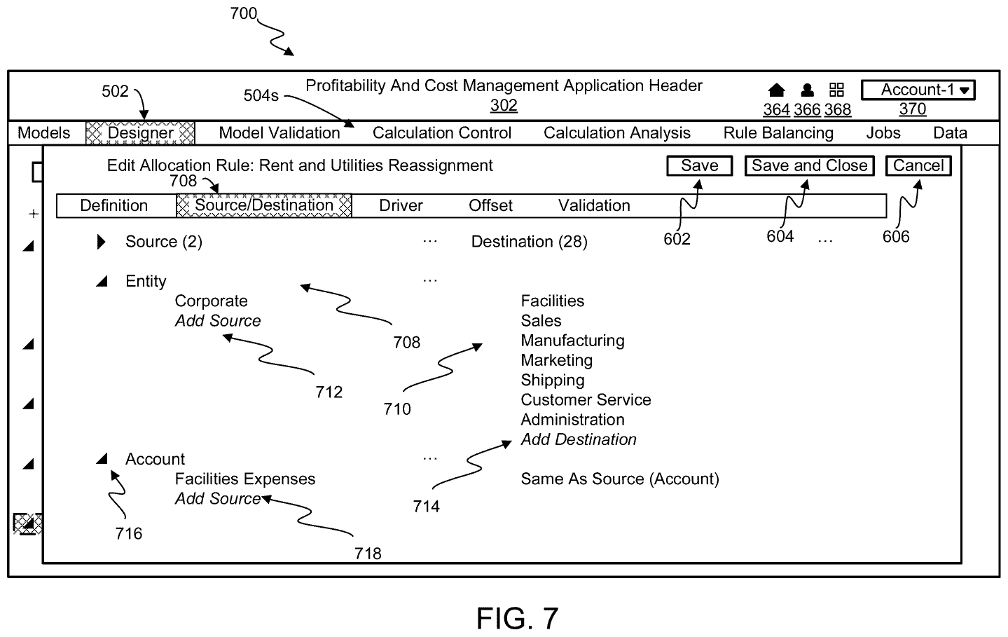

The source/destination tab of a rule defines what data transformation or movement of data is accomplished by the rule, as shown in the example source/destination for the “Rent and Utilities Reassignment” rule in the example interface 700 of FIG. 7. As shown in Source/Destination navigation option 708, the “Facilities Expenses” accounts indicated as accounts 716 from the source entity, “Corporate” indicated as entity 708, are allocated to the target entities (e.g., Facilities, Sales, Manufacturing, Marketing, Shipping, Customer Service, Administration, etc.) indicated as destinations 710 while preserving the same account ID as was used when storing Facilities Expenses for the Corporate entity. Options 712, 714, and 718 are included for adding sources and destinations to edit the allocation rule shown. The rule shown may be one of hundreds or thousands of rules operating in sequence as data is moved around and transformed in the system.

The rules move data from one location to another, and the ingested data may be further transformed and moved to another location. For example, the expense of running the legal department may be determined based on personnel salaries, facilities space occupied, IT support consumed, software consumed, utilities consumed, etc. These various expenses may be recognized by other departments and apportioned to the legal department to determine the expense of running the legal department. The steps of apportioning the costs of the other organizations to support the legal department are used to determine the expense of running the legal department. Before rolling up facilities expenses, the facilities expenses must first be apportioned to the legal department, and then the apportioned expense may be rolled up and combined with other apportioned expenses to determine the cost of operating the legal department.

The rulesets involve data allocation or transformation such that apportioned parts of resources may be allocated to other departments for the purpose of determining operating expenses of the other departments. In the example, the development organization may be based on the total expense of running the legal department to the extent that legal services have been provided to support development. Without first determining the total expense of running the legal department, the total expense of running the development department cannot be accurately determined. For this reason, allocations from service organizations supporting legal, which is also a service organization, are done before allocations from divisions supporting development, which is a revenue generating service consumption organization. In this manner, waterfall allocations flow down through a larger organization from sub-organization to sub-organization as resources are allocated, partitioned, and re-allocated to other sub-organizations.

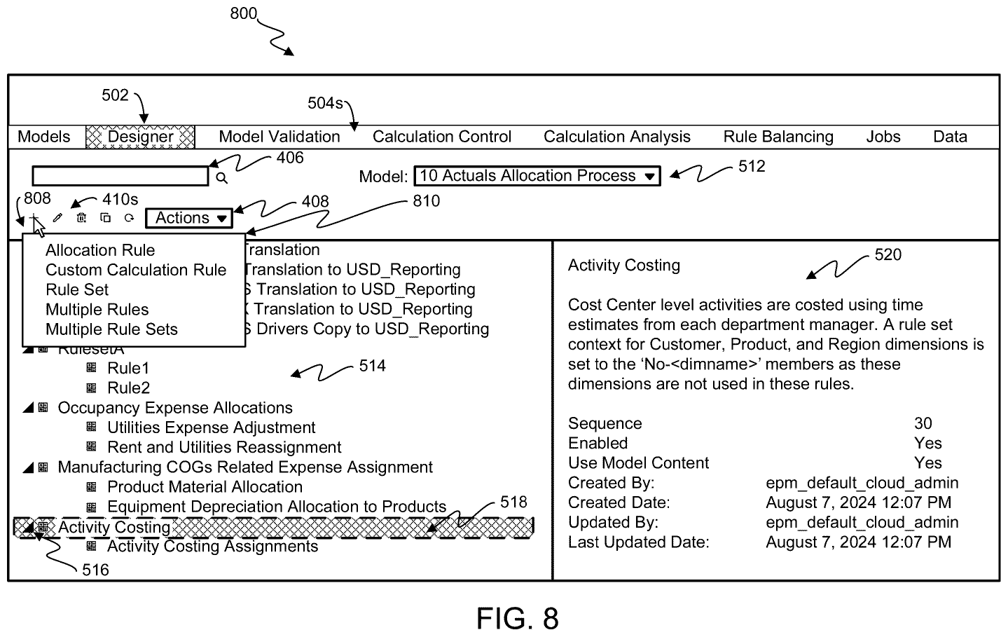

Using a mouse and keyboard, models, rulesets, and rules, can be created and customized in the user interface. In the example interface 800 shown in FIG. 8, a plus sign 808 may be selected to create new rule(s) and/or ruleset(s) as indicated by options 810, including, in the example, a new allocation rule for dividing allocations between divisions, a custom calculation rule for transforming data, a rule set that holds related rules, multiple rules, or multiple rule sets. Each pathway may include shortcuts for frequently used rules that may be modified, but these UI navigation pathways and shortcuts do little to limit the number of clicks performed by the user to set up complicated models involving many rulesets.

### Using Generative AI to Manage Waterfall Models

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, etc. Different models may be used in different scenarios, and the techniques described herein are LLM-agnostic. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a data schema of multidimensional data available in a user session with an application. The data schema may include dimension names, member names, and drill-down and roll-up hierarchies that are available to view or manipulate in the user session. The data schema may be formatted in a hierarchical format, such as JSON, XML, or another structured and delimited format that distinguishes between members at different levels of the hierarchy.

The prompts may also specify a format for providing the reply, through examples and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{” and “}” or “[” and “]” in the response. The consumable JSON object may be separated from a remainder of the response for consumption by the application to create an executable structure to trigger application functionality.

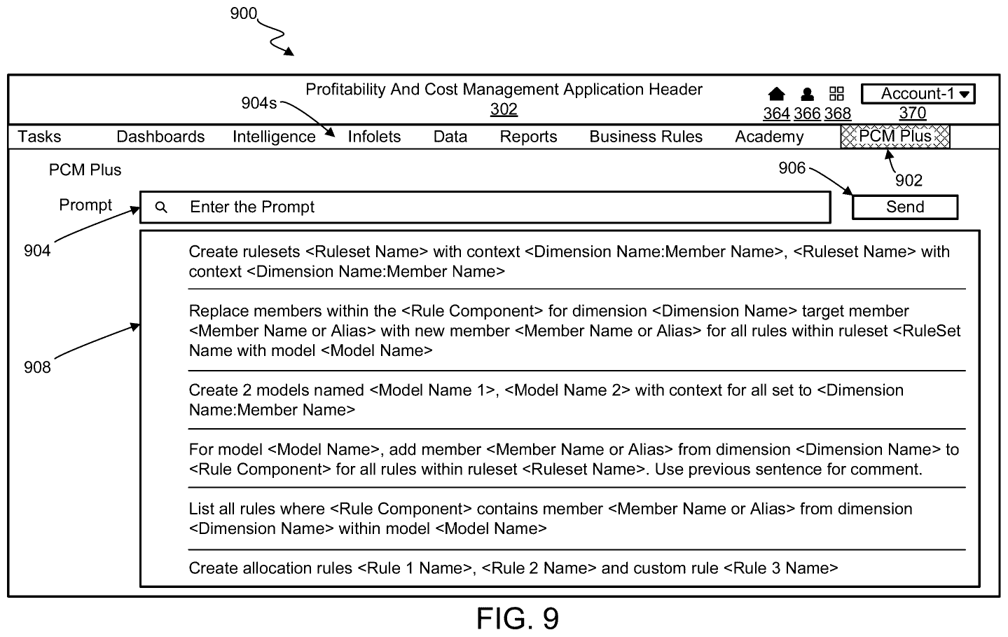

In one embodiment, a profitability and cost management agent may help users generate and configure models, rulesets, and rules, to more effectively manage the models, rules, and their structure and dependencies. The agent may support natural language input that targets creation or modification of models, rulesets, or rules. As shown in interface 900 of FIG. 9 within a selected PCM Plus navigation option 902, a text input region 904 is displayed for inputting requests into the system. The agent may display example requests 908 that are predictably and reliably understood by the agent as good examples or starting examples, and the user may select from one of the starting examples 908 as a starting point for customizing the input before sending the input to the agent using send option 906. The starting examples 908 may have placeholders for variables or object names, such as “<Model Name>”, “<Rule Name>”, “<Rule 1 Name>”, and/or “<Rule 2 Name>.”

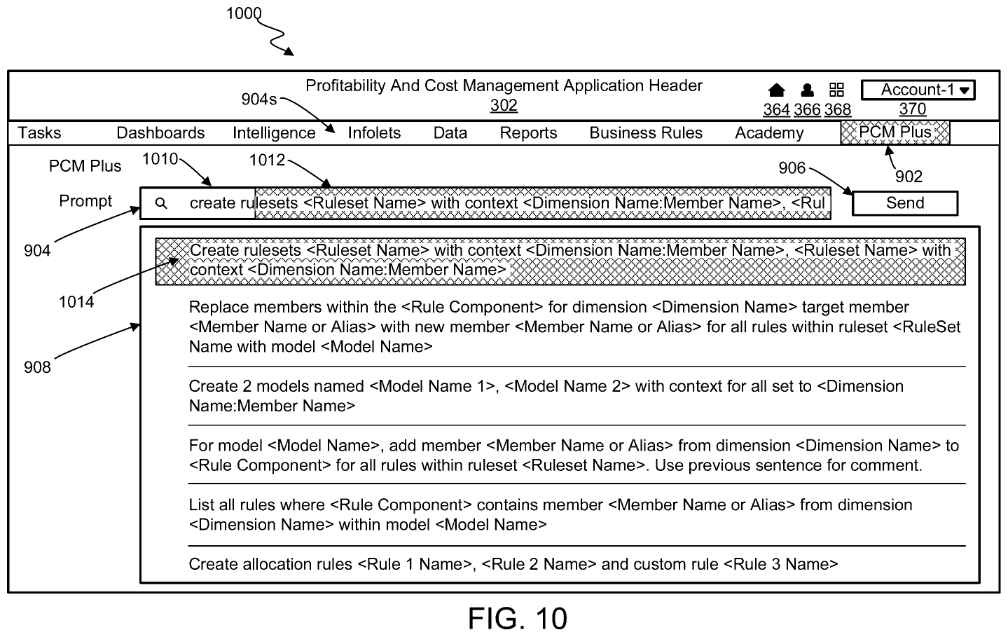

As shown in interface 1000 of FIG. 10, as a user begins to type a request 1010 into the text input region, the agent may autocomplete the request with the closest matching starting example 1012 known to the agent as a type ahead or other suggestion feature. In some examples, the agent may substitute the placeholders for actual values when determining the type ahead options to avoid suggesting specific values that have been selected in the past but to focus on the structure of the command. The closest matching starting example may include placeholders for variables or object names even though requests with the placeholders are unlikely to have been processed successfully in the past.

The agent may receive a request once the placeholders have been replaced with actual variable values and actual object names by the user, optionally with additional text added that does not match any example.

Based on the user input, the agent may prompt an LLM with starting examples paired with corresponding example output as well as the user-specified request and instructions for the LLM to generate output corresponding to the user-specified request. In this manner, the user input is combined with a prompt template to generate a prompt to be sent to the LLM to trigger the LLM to generate a response object that causes application functionality in accordance with the user input.

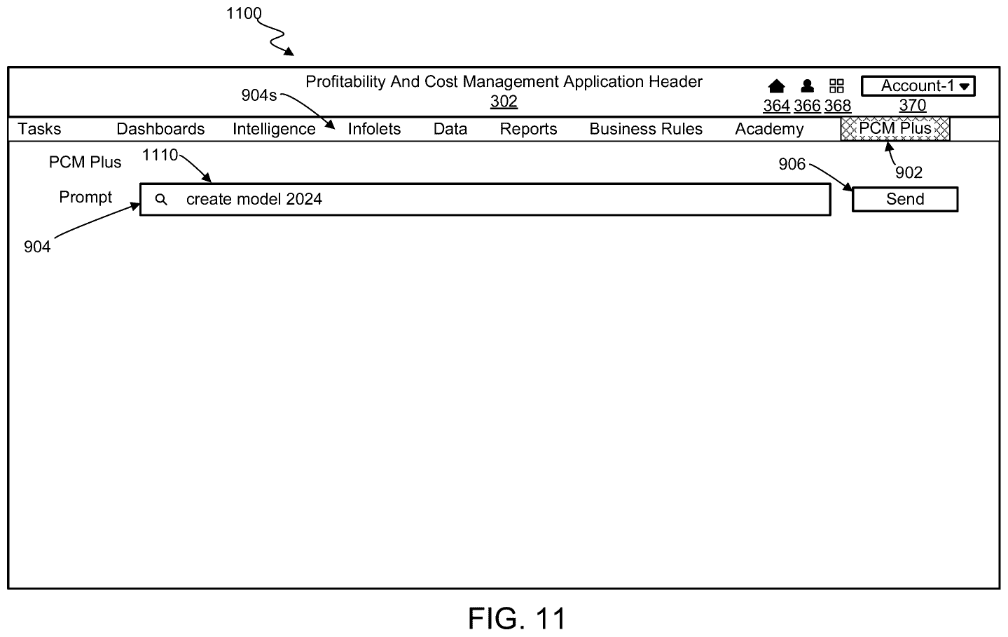

In one example shown with the example user interface 1100 of FIG. 11, a model is created using the user-specified request 1110, “create model 2024.” If the user-specified request exactly matches a known pattern of user-specified requests, the model may be created, or a proposed version of the model may be created, according to the instructions stored in association with the known pattern. If the user-specified request does not exactly match a known pattern of user-specified requests, an LLM may be prompted with information from the user-specified request and examples of prompts that are matched to application instructions. For example, the user-specified request may include an optional description, optional context, dimensional data, or member value, or other optional parameters or metadata for the model, and such information would be included in the created model. Based on a response from the LLM, the model may created, or a proposed version of the model may be created, according to instructions provided by the LLM.

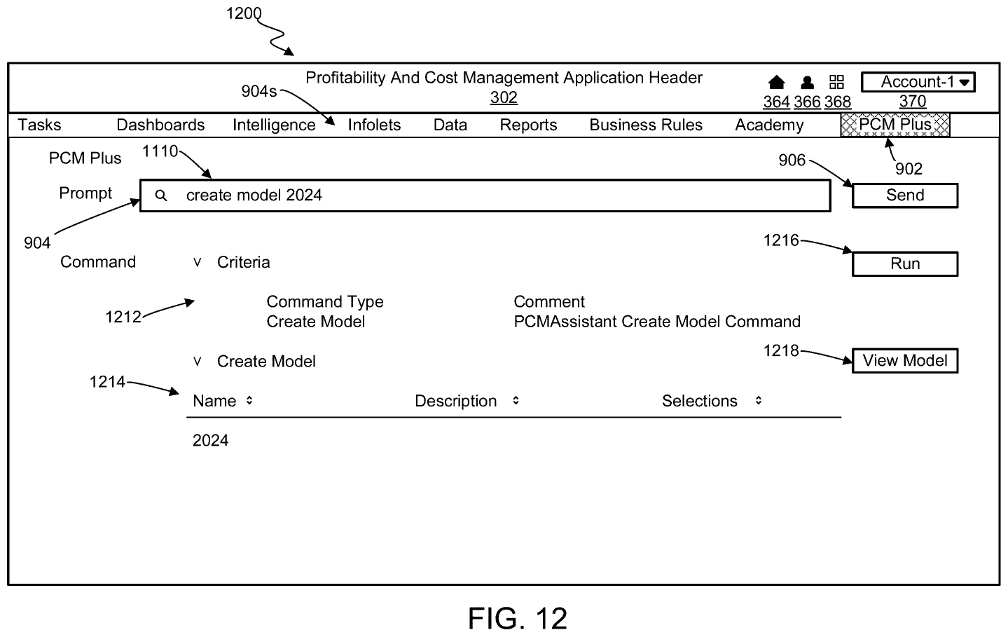

As shown in the example user interface 1200 of FIG. 12, a proposed version of the model or a data structure representing the proposed model is created and shown to the user, with criteria 1212 and object details 1214 shown, before the user selects the “run” command 1216 to create and store the model in a directory of models in the system. The user interface may also allow the user to drill into the proposed model, via option 1218, to view lower-level details about the model to be created, or to approve and run the model creation command based on higher-level object details 1214 shown, such as the name of the model, “2024.” In addition to showing the structure of the object that will be created when the model create command is run, the user interface also shows the command type as create model and additional details such as criteria 1212 about the command type, as PCMAssistant Create Model Command. Previewing information about the command to be executed allows the user to review the proposed model before triggering the corresponding functionality in the system, to ensure that the response from the LLM is in line with what the user expects to be done in the system. By using, for the preview, a data structure that matches the data structure that will be consumed to perform the actions, the agent can ensure that the user understands the intended function to be performed in the system when the user selects to run the previewed command.

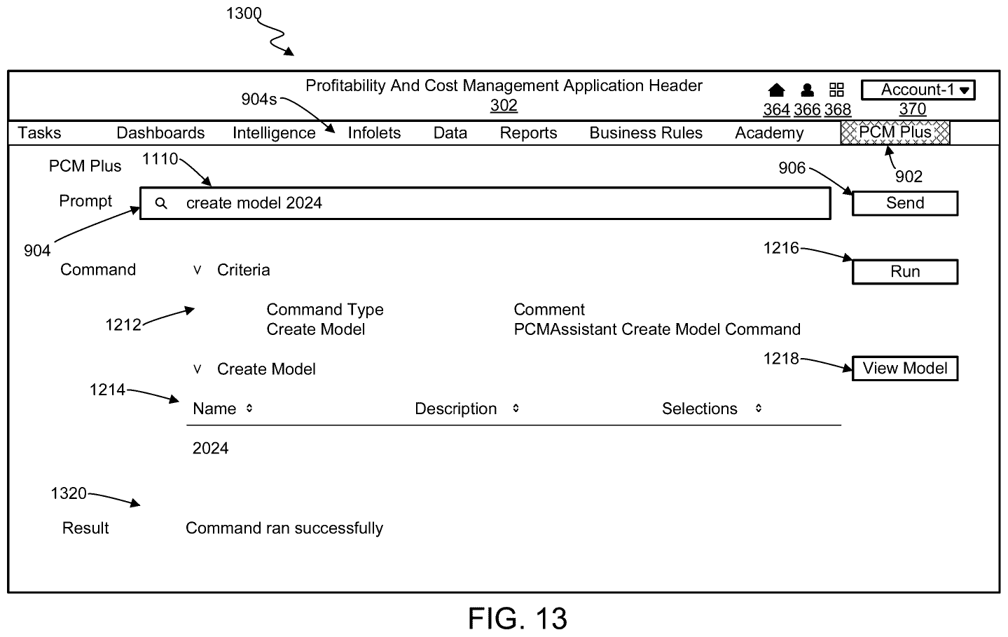

Upon running a command, a graphical indication 1320 may be displayed indicating that the command has run successfully, as shown in the example interface 1300 of FIG. 13. The model may also be viewed by navigating to the view model option 1218 of FIG. 13.

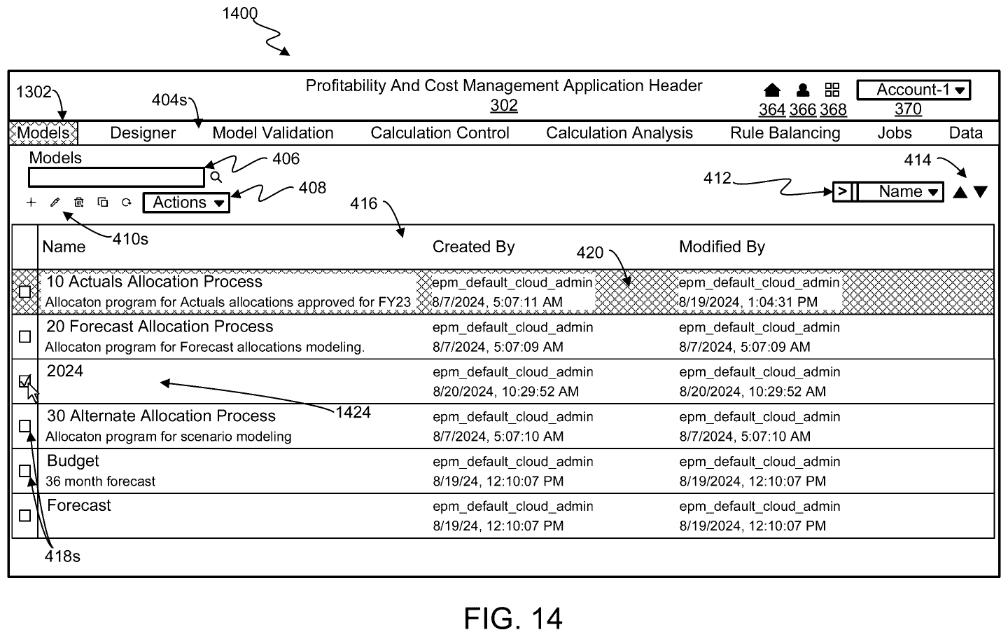

Once created, the newly created model 1424 may be visible under a model navigation option 1302 in a directory or listing of existing models, as shown in the example interface 1400 of FIG. 14.

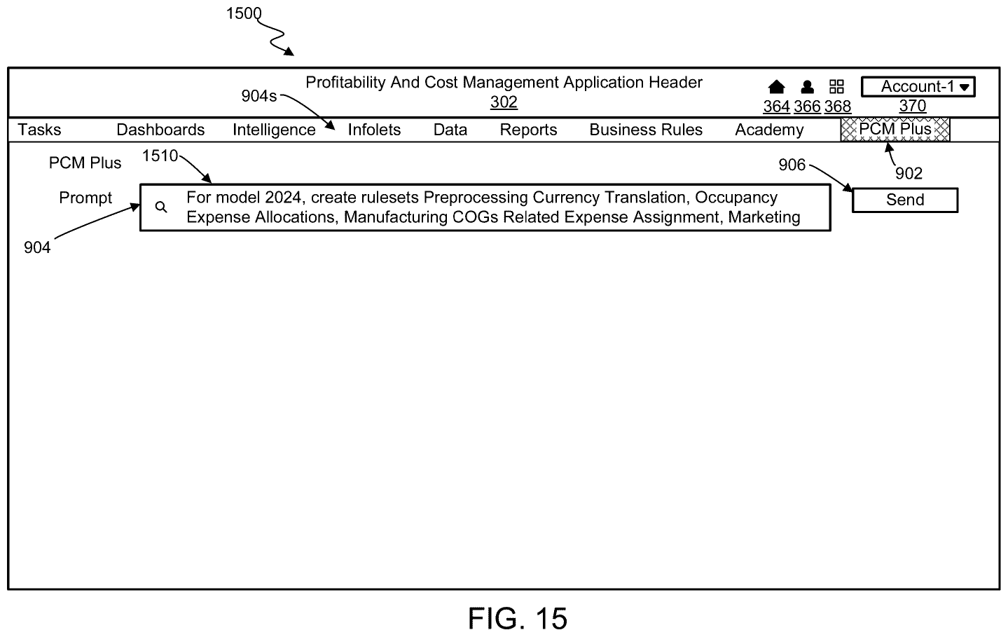

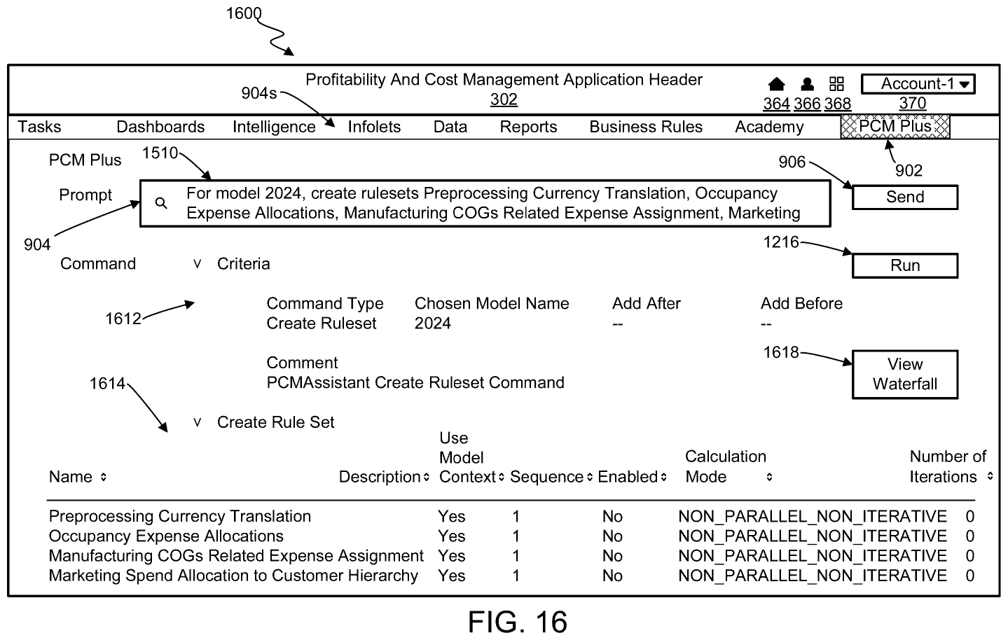

The text input region may also be used to create or configure rulesets or rules. In the example interface 1500 of FIG. 15, the text input region 904 receives text 1510 for creating multiple rulesets for the 2024 model. Upon sending the text input to the agent, the agent proposes execution of a command to create the rulesets configured as shown in user interface 1600 of FIG. 16, with names and default or configured values shown in the proposed data structure object details 1614 and, in criteria 1612, the command type create ruleset identified for the chosen model 2024, with details about the command being run also being shown. The waterfall allocation for the ruleset may be viewed in more detail using the view waterfall option 1618. Upon running the command against the system, the rulesets are added to the model 2024 as outlined.

The ruleset creation command may include other details about the rulesets, such as descriptions or other properties, that can also be passed in via the text input region in the same request. If a property for the ruleset shows up incorrectly, the text input region can be modified, and the request can be re-sent by the agent. The re-sent command may cause the additional parameters to be updated based on the updated text input region, and then the command may be run as corrected.

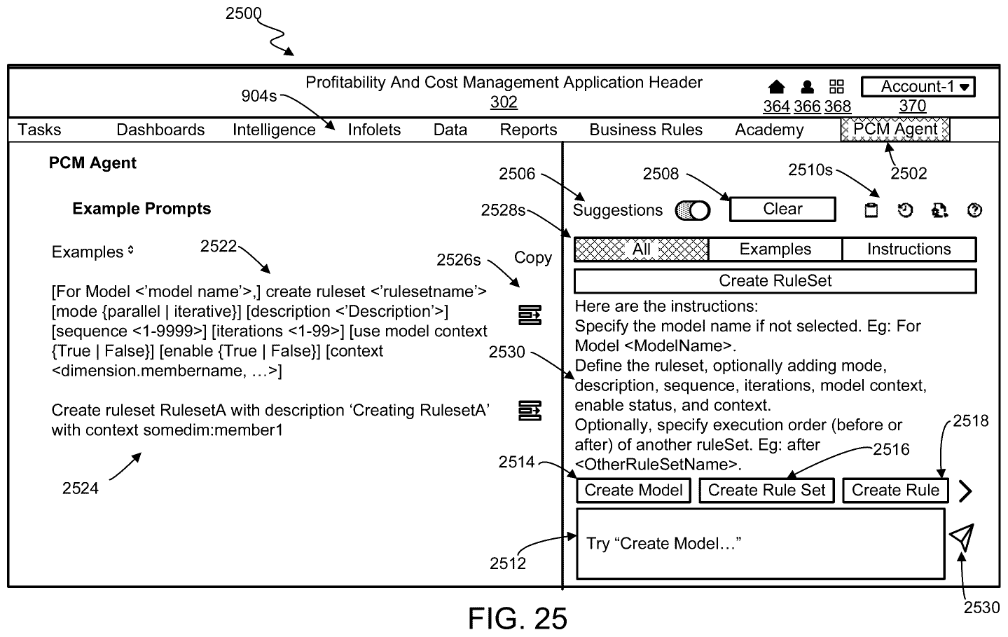

In the example interface of FIG. 25, a PCM agent sub-interface is selected as shown via indicator 2502. In the PCM agent sub-interface, text input region 2512 is used for creating models, rulesets, or rules using guided natural language input. Example templates 2522 and 2524 are provided, with options 2526s to copy the example templates to the text input region 2512 for further modification or submission using submit button 2530. Instructions are provided in region 2530 for example templates, such as the create ruleset template. Suggestions relevant to natural language input in region 2512 and/or selected examples may be enabled or disabled with toggle 2506, causing additional information to be displayed in region 2530 and/or typed ahead in region 2512 based on inputs provided with respect to region 2512 and/or selected examples 2522 or 2524. Views may be adjusted via view selections 2528s to show examples, instructions for the natural language input, or both. Examples and/or instructions may be switched to appropriate contexts with context selection buttons 2514, 2516, and 2518. The context selection buttons 2514-2518 cause examples 2522 and 2524 and/or instructions in region 2530 to change to correspond to the selected context, such as “Create Model,” “Create Rule Set,” and/or “Create Rule.” In one embodiment, the instructions are selected using RAG as instructions that are closest to the selected example. In another embodiment, instructions are stored in association with each example or context and displayed in association with the selected example or context. Instructions may provide details about what impact changing different parameters of the examples may have on the command's functionality.

In one example, the context selection buttons 2514-2518 are limited to only those context selections that are potentially relevant to input already provided in input region 2512. The clear button 2508 causes examples 2522 or 2524, instructions 2530, and/or inputs in 2512 to be cleared out so that user input may be restarted with a clean slate. Icons 2510s allow additional tools to be used in conjunction with input into region 2512, such as copying to and/or pasting from a clipboard, displaying or hiding prototypes or examples whether or not a context has been selected (with various placeholders or alternative valid available values shown in various portions of the example template), applying default or suggested values or leaving placeholders in examples, a view of input history for input from region 2512, delaying submission of instructions to cause models, rules, and/or rulesets to be created at a specified time, access to additional help materials, and/or use of additional user input tools and/or access to prompt configuration settings.

In one embodiment, instead of using pseudo-names, such as “somedim” and “member1” indicated in example 2524, the dimensions may be selectable from actual dimensions that exist in a back-end multidimensional database, with members selectable from the members that belong to the selected dimension. In this manner, the example may be selected using a single input from options 2526s and submitted using a single input such as submit button 2530 to cause the corresponding command to be performed in light of existing dimensions and members in the multidimensional database. Before or after the examples are copied from examples 2522 or 2524 to region 2512, the examples may include placeholders graphically marked with drop-down options to change a selection from existing dimensions and/or existing members that are valid for the corresponding examples such that examples may be efficiently submitted with valid inputs without requiring the user to have a comprehensive understanding and faultless memory of the underlying multidimensional database dimensions and members.

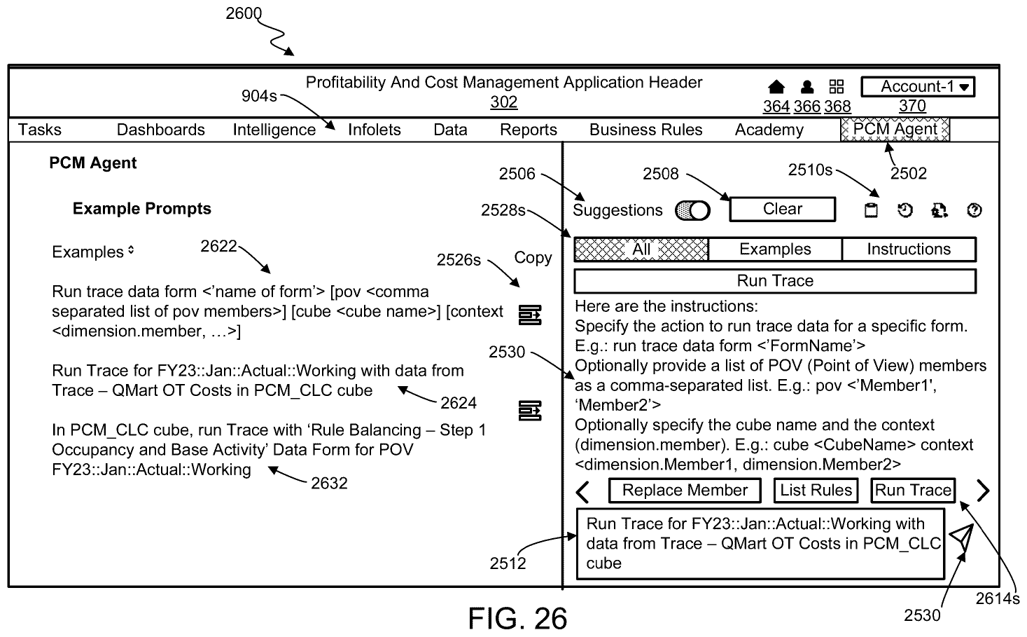

FIG. 26 shows an example interface where inputs are suggested based on existing data. As shown, example 2624 is selected from examples 2622, 2624, and 2632 to cause display of the example in input region 2512. Upon submission of the example with or without further modification and with or without further user input, the example operates on existing data to perform the selected function (“run trace” in this example). If the example is generic, a user would need to select the example and substitute real values for placeholders in the generic template. If the example is customized to the user's dataset already before selection, the user may select the example and run the example using submit button 2530 without further customization of the example.

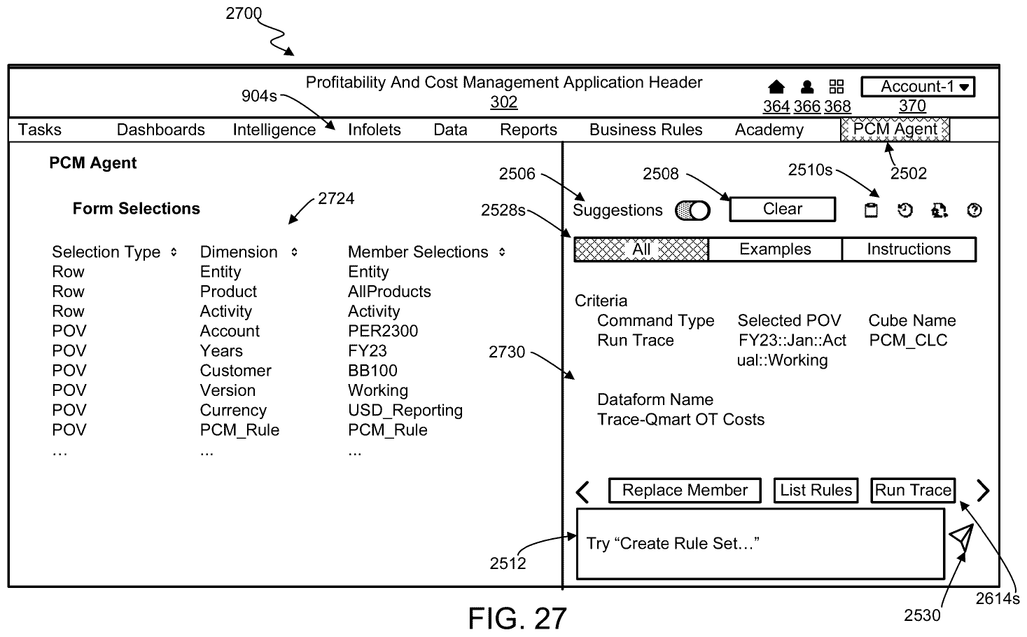

FIG. 27 shows an example result of running the example input selected from FIG. 26. As shown, the example performed the function “run trace” for pre-selected POV FY23::Jan::Actual::Working from existing cube name PCM_CLC and resulted in form selections 2724 based on criteria 2730 used in the trace.

Default values may be selected for examples based on the data that exists in the user's accessible dataset. The default values may be the first values returned, the most frequently used values in lookups or agent submissions via input region 2512, based on historical data values in the dataset, based on the current date or quarter (e.g., using values closest to the current date or quarter), the largest or most frequently accessed data, randomly selected, based on user-specific settings stored for a user session in which interfaces 2600 and 2700 are shown, or in any other manner. For new items being created, the values may be selected based on historical naming patterns for other items of the same type. For example, if an item receives a name starting with the Month and Year, the system may detect the pattern of using the Month and Year in the name and substitute the current Month and Year in the placeholder for the name. The system may also detect increments, such as “rule1,” “rule2,” “rule3,” in the name and use an incremental value for the newly proposed name, such as “rule4.”

Default values may also be selected based on values used or configured to be used in other items of the same type. For example, a rule for allocating fixed costs may be configured to be added or detected for addition to each ruleset based on the rule being used frequently in rulesets.

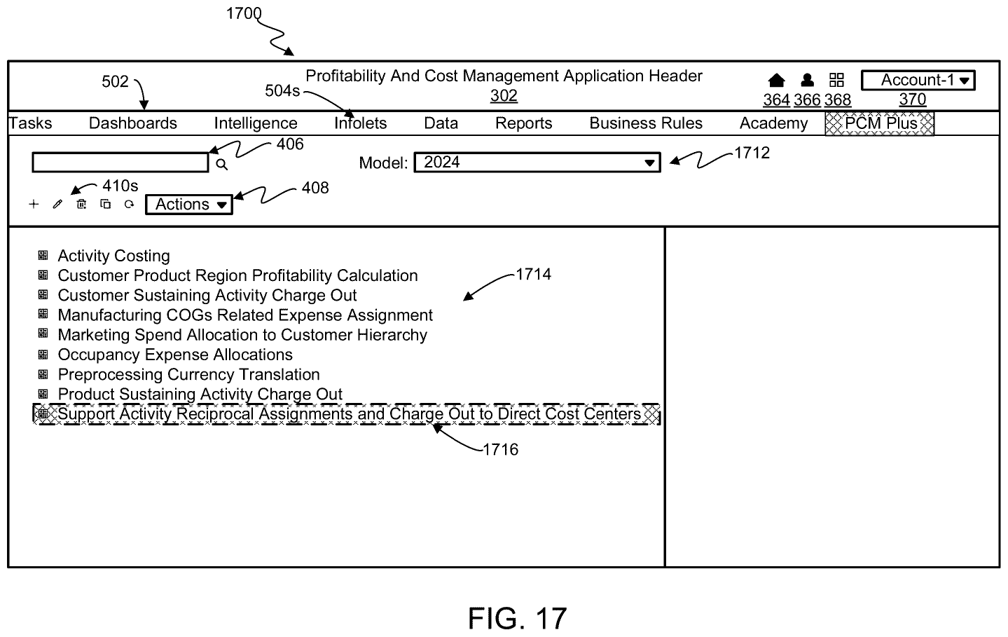

In the example interface 1700 of FIG. 17, the created model 2024 is viewed, indicated in the model selection option 1712, with the rulesets 1714 that were created using the text input region to generate the data structure with the LLM, with the data structure being confirmed by the user and run against the system. As shown, the rulesets appear in the model and are selectable. In the example, ruleset “Support Activity Reciprocal Assignments and Charge out To Direct Cost Centers” is being selected as indicated by selected shaded region 1716 for further viewing and/or modification.

In various embodiments, content such as model(s), ruleset(s), and/or rule(s) may be selected when text input is provided to the agent. The selected model(s), ruleset(s), and/or rule(s) may be added to the type ahead text for easier specification in the text input region. In another embodiment, the selected model(s), ruleset(s), and/or rule(s) are sent to the LLM as background context for the request that was typed in, even if the request did not specify the selected model(s), ruleset(s), or rule(s). For example, the request may just say “rename to ‘Customer Product Region Revenue Calculation’” while “Customer Product Region Profitability Calculation” is selected, causing a proposed change in the name to “Customer Product Region Profitability Calculation” without ever having to type in the selected object into the text region. In another example, from within a user interface specific to a model or ruleset, requesting to “create a rule” may create a rule for the corresponding model and ruleset in which the user interface is nested without requiring the user to specify the model or ruleset in the text region. For example, the additional context may be supplied to the LLM so the LLM is informed that the request was provided when the user was looking at a particular ruleset.

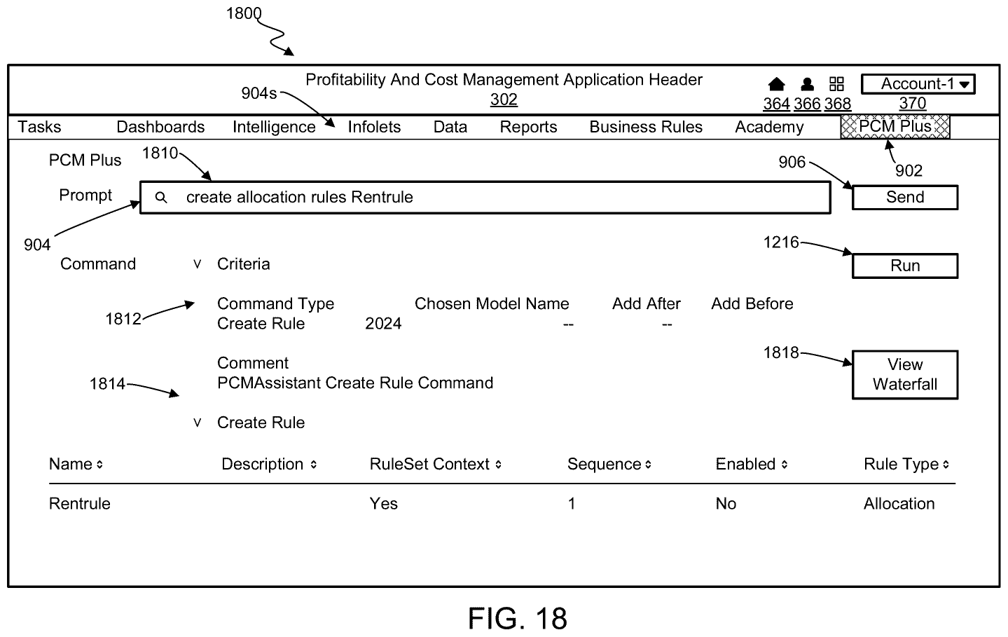

As shown in the example interface 1800 of FIG. 18, the input text region 904 may receive input 1810 that requests to create allocation rule rentrule. In response to the request, the agent prompts the LLM for a structure that defines the requested action. The structure is returned and displayed, as criteria 1812 and object details 1814, on the user interface for confirmation that the structure accurately represents the action intended. As shown, the command type is previewed as Create Rule against chosen model 2024 even though 2024 was not specified. The rentrule is previewed with various parameters assigned to rentrule, such as rule type allocation. Allocation rules summarize the amounts of a range of cells and apply the amounts to another range of cells using a metric to determine apportionment. Another type of rule, custom calculation rules, are transformations of data based on a provided formula. The waterfall allocation for the rule may be viewed in more detail using the view waterfall option 1818. Upon running the command for the allocation rule specified in the example, the rentrule is created.

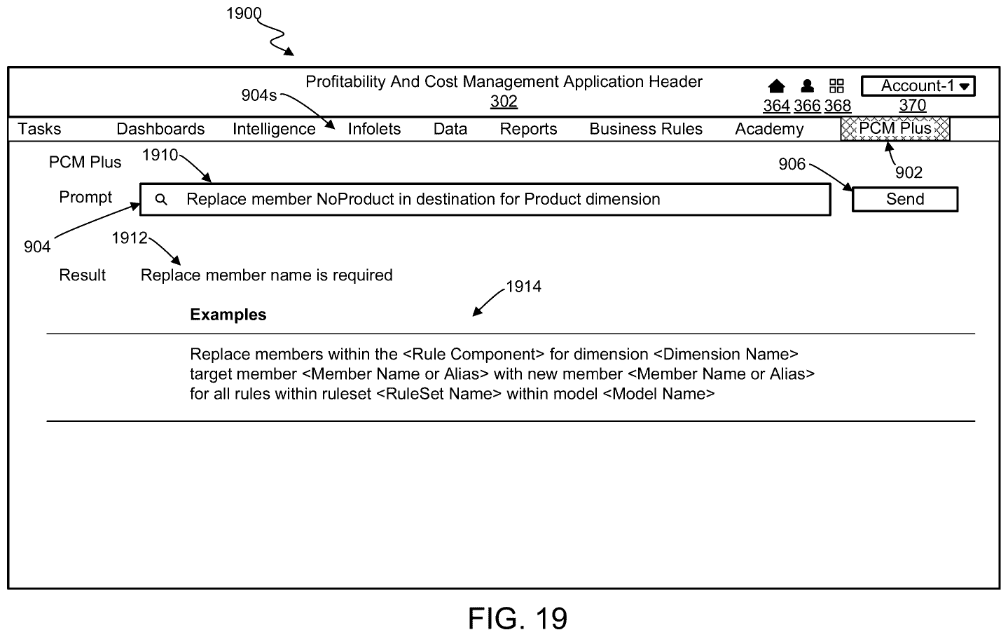

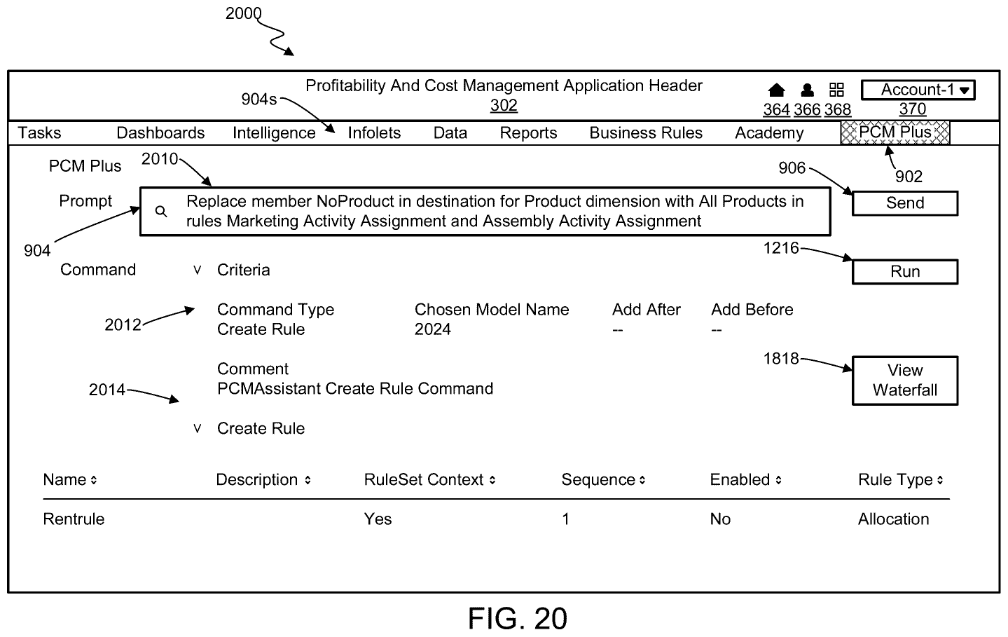

Other model management commands that may be triggered include, but are not limited to, listing models, rulesets, or rules, replacing member(s) of model(s), ruleset(s), or rule(s) with other members of model(s), ruleset(s), or rule(s). In the example shown in the example interface 1900 of FIG. 19, the text region 904 receives input 1910, “Replace member NoProduct in destination for Product dimension.” Based on the examples provided to the LLM, a result 1912 is provided that indicates “Replace member name is required,” along with examples 1914 of how the member name should be supplied. In the example, a proposed structure is provided as “Replace members within the <Rule Component> for dimension <Dimension Name> target member <Member Name or Alias> with new member <Member Name or Alias> for all rules within ruleset <RuleSet Name> within model <Model Name>.” In this manner, the agent and LLM work together to guide user input that is valid for generating a data structure to trigger valid functionality in the system. In the example interface 2000 of FIG. 10, the user may correct the command to type the text 2010, “Replace member NoProduct in destination for Product in destination for Product dimension with All Products in rules Marketing Activity Assignment and Assembly Activity Assignment”. As a result, the member NoProduct is found for the Product dimension and replaced with all of the products in existing rules Marketing Activity Assignment and Assembly Activity Assignment. Criteria 2012 and object details 2014 are shown for the proposed rule to be created. The precise existing rules in these other rules need not be specified in the request, as the agent provides context to the LLM so the LLM can generate the appropriate data structure to make the proposed replacement.

### Using Generative AI to use Waterfall Models

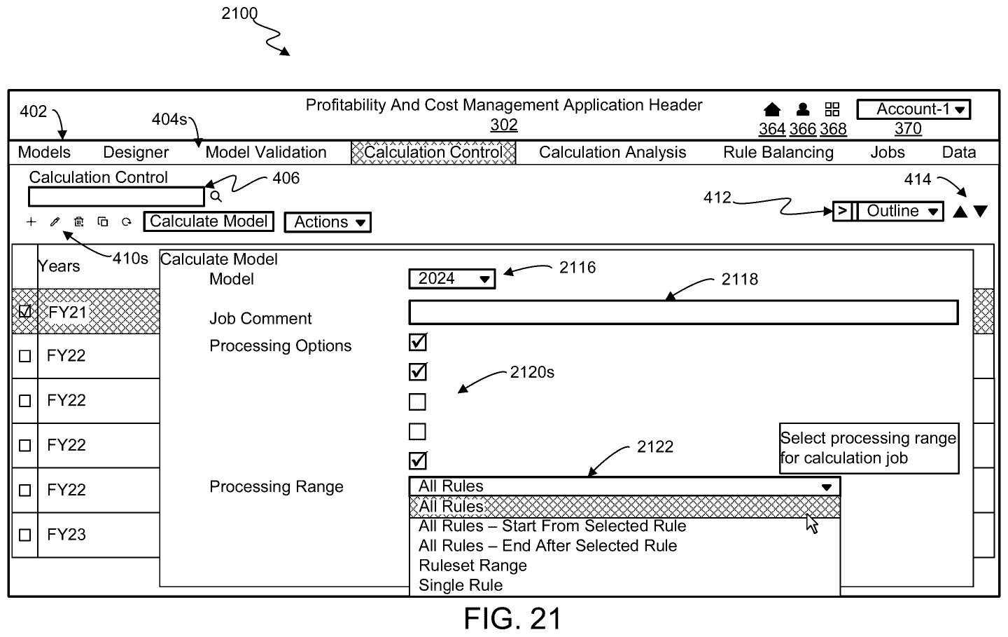

Model usage commands may also be triggered. As shown in example interface 2100 of FIG. 21, models may be run on selected slices of data (defined by various members of various dimensions) with various processing options 2120s shown that may be configured for each run of the model. The model 2116 may be run to include all rules as shown in option 2122, with other selectable options including starting from a selected rule, ending after a selected rule, for a given ruleset range, or for only the selected rule(s). Additional input may be provided for a job comment 2118. Running models to perform calculations and/or update allocations may also be triggered via the text input region to cause calculations or updated allocations to be determined based on existing rules. In these embodiments, confirmation steps may outline the operations to be performed, the slice(s) involved, the model(s), ruleset(s), or rule(s) that are included, and other parameters that impact the operation of the function.

### Classifying User Input Using an Intent Classifier

In one embodiment, before a prompt template is selected for the user input, intent of the user is classified using an intent classifier. For example, the user input may be mapped to a create model prompt, a mass edit prompt, and/or a model usage prompt based at least in part on content of the user input. In one example, the intent classifier may look for keywords associated with commands (e.g., different terms or phrases that may be used to trigger the commands) in each of the different classes of prompts to match the keywords from the inputs to the appropriate classes of prompts. The prompt templates in those classes may include example commands to the LLM for commands that are exclusive to the class, or commands that are common in the class. In this manner, prompt templates may be tailored to accept input relating to certain commands.

In another example, the intent classifier matches user input to prompt templates based at least in part on distances or similarities between a vector embedding of the user input and different vector embeddings associated with the different prompt templates and/or the different examples represented within the different prompt templates. The closest prompt template, for example, in terms of cosine similarity, may be chosen as the prompt template to use for processing the user input.

In yet another example, a machine learning model is used to match user input to prompt templates based at least in part on the content of the user input and the content handled in the examples of the prompt templates. The machine learning model may incorporate feedback from the user when user input is correctly or incorrectly matched to corresponding commands. For example, a user selecting to run a command on confirming that the structural representation of the command is correct may be treated as positive feedback, and a user selecting not to run the command and/or to generate a different command may be treated as negative feedback.

In yet another example, an LLM may be used to match user input to prompt templates based at least in part on the content of the user input and the content handled in the examples of the prompt templates. The different examples handled by the different prompt templates, or samples therefrom, may be grouped by template and provided to the LLM via a prompt that also includes the user input and a request for the LLM to select the closest group to the user input. The prompt template corresponding to the closest group may be selected to handle the user input.

Different types of prompt templates may be designed to handle different types of commands or requests. In various examples, mass edit commands may be done by a first prompt template that is classified with a mass edit command classification. In one example, the mass edit commands include an example command to replace members within the target for dimension Account target member Net Income with new member Facilities Expenses for all rules within model 10 Actuals Allocation Process. In another example, the mass edit commands include an example command to Insert NoProduct from Product into destination for all rules in rulesets Product Sustaining Activity Charge Out, Activity Costing. In various examples, waterfall commands may be done by a second prompt template that is classified with a waterfall command classification. In one example, the waterfall commands include an example command to Create allocation rules Marketing Activity Assignment, Shipping Activity Assignment, Assembly Activity Assignment, Machining Activity Assignment, Finishing Activity Assignment, Quality Assurance Activity Assignment and custom rules Activity Unit Cost Preparation. In another example, the waterfall commands include an example command to Create 3 models named Actual, Budget, and Forecast with the model context all set to NoDriver. Various other classifications are possible, and any number of prompt templates and classifications may be used in different implementations.

### Defining Output Object Structure to the LLM

In one embodiment, the agent generates a prompt to the LLM that includes various examples of valid output object structures that are consumable by the application or agent to cause corresponding application functionality. The LLM consumes the examples of valid output object structures provided for various input circumstances and generates valid output conforming with the expected data schema common among various examples. When the LLM is prompted by different prompts based on different prompt templates, the structural difference of the command response that is output by the LLM is being guided based on divergent examples in divergent prompt templates for the LLM. The different prompts may have different components or reference different data structures to trigger different commands causing different functionality in the application.

In one example, in the prompt examples section, the LLM is requested to generate a response in light of the following example, where the Response provides the following delimited components cmdType, modelName, dimension, newMembers, members, findMembers, replaceMembers, ruleComponents, allRules, rules, rulesets, Operator, and Comment. The LLM can infer the delimiting syntax among multiple examples that use the same delimiting syntax. In various embodiments, examples may be selected from a data store to select examples that are similar to the user prompt based at least in part on cosine similarity between the stored examples and the user prompt or otherwise by using RAG. One such example prompt and response is:
User_Prompt: ‘‘‘For model aModel, add member member1 from dimension somedim to source for all rules within RuleSetA. Use previous sentence for comment.’’’
Response: {““cmdType””: ““Add Member””, ““modelName””: ““aModel””, ““dimension””: ““somedim””, ““newMembers””: [““member1””], ““ruleComponents””: [““SOURCE””], ““allRules””: true, ““rules””: [], ““rulesets””: [““RuleSetA””], ““comment””: ““For model aModel, add member1 from dimension somedim to component SOURCE for all rules within RuleSetA.””}

In addition to or in alternative to providing the expected structure through examples, the LLM may be directly instructed to conform responses to a particular schema. In the prompt examples section, for example, the LLM is requested to generate a response in JSON conforming to the following schema that defines an output structure:
{
““cmdType””: <insert command type>,
““modelName””: <insert model name>,
““dimension””: <insert dimension name>,
““newMembers””: <insert new members>,
““members””: <insert members>,
““findMembers””: <insert find members>,
““replaceMembers””: <insert replace members>,
““ruleComponents””: <insert rule components>,
““allRules””: <insert all rules>,
““rules””: <insert rules>,
““rulesets””: <insert rule sets>,
““Operator””: <insert operator>,
““Comment””: <insert user comment>
}

### Defining Acceptance Criteria to the LLM

In one embodiment, the agent generates a prompt that provides acceptance criteria to the LLM such that the LLM can filter and process results before returning them to ensure they meet all of the acceptance criteria. In various embodiments, acceptance criteria may be selected from a data store to select acceptance criteria that are similar to the user prompt based at least in part on cosine similarity between the stored acceptance criteria and the user prompt or otherwise by using RAG. In various embodiments, the number and complexity of the acceptance criteria may be increased or decreased by the removal or addition of domain-specific terminology to the prompt. For instance, 15 criteria may be sufficient in some examples, and 20 criteria may be sufficient in other examples. Using a RAG store to select relevant criteria could simplify the criteria and reduce the count. In some embodiments, prompt grammar may be further improved or extended in a way that decreases or increases the number of criteria to be used, with or without domain-specific terms and with or without a RAG store.

Example acceptance criteria include, but are not limited to:
1. ““cmdType””object can have any one of the following values:
   a. ““Add Member””: When the user requests to add a new member and corresponding to this ““newMembers””object gets the new member as value.
   b. ““List Rules””: When the user requests to list rules for a particular condition and corresponding to this ““members”” object gets the member in that condition as value.
   c. ““Replace Member””: When the user requests to replace existing members with new ones and corresponding to this
““findMembers”” object gets the members to be replaced(existing members), and ““replaceMembers”” object gets the replacement members (new members as replacement).
   d. ““Unknown””: When the tokens within the sentence do not map to a command type of either ““Add Member””, ““List Rules””, or ““Replace Member””.
2. ““modelName””: Name of the model specified in the user query, otherwise defaults to the current model.
3. ““dimension””: Dimension name specified in the user query or the given dimension list.
4. ““newMembers””: associated to ““cmdType””: ““Add Member”” and may include multiple member values.
5. ““members””: associated to ““cmdType””: ““List Rules””.
6. ““findMembers””, ““replaceMembers””: associated to ““cmdType””: ““Replace Member””.
7. ““ruleComponents”” object can be any of the following: [““SOURCE””, ““DESTINATION””, ““DRIVER””, ““OFFSET””, ““TARGET””].
8. ““rules””: a required property within the output identifying zero to multiple values associated with the rule token.
9. ““rulesets””: any ruleset talked about in the user query.
10. ““allRules””: Is a required boolean flag (TRUE or FALSE) indicates when the query applies to all rules within the model.
   a. If ““rulesets”” has one or more values, then the value of ““allRules” is true.
11. ““Operator””: is operator performed by a filter condition associated with the ““rulComponent””. The operator list contains the valid operators. The default value is ““CONTAINS””.
12. ““Comment””: can be any of the following: [““PCMAssistant Add Member Command””, ““PCMAssistant Replace Member Command””] or the user can have custom request.
13. Don't include Model within model name unless Model is enclosed within double quotes.
14. The operator_list variable contains the valid operators.
15. When a model is not provided, default the model name to the value of the current_model variable.
16. When a rule component is not provided, default the value to SOURCE.
17. Use dimension_list variable to identify values associated with the dimension property.
18. Don't include Component within rule component unless Component is enclosed within double quotes.
19. If user prompt is missing key words, map those keywords to an empty string or empty array.

In the examples, the LLM is instructed of the command types that are available and scenarios where those command types are appropriate, the definitions of dimension, members, rules, and rulesets objects, the parameters modelName, newMembers, findMembers, ruleComponents, allRules, Operator, and Comment, and specific instructions on how to handle models, operators, dimensions, components, and missing keywords, as well as default values to use in certain scenarios.

### Defining Functionality by Example to the LLM

In one embodiment, the current model, dimension list, operator list, and/or any other user session context or user interface context are provided to the LLM as part of the prompt even if they were not specified in the user request. The context may specify what objects are selected on the screen, what objects are being manipulated by the user, what objects have most recently been viewed by the user, or any other background about the user session that may be helpful for the LLM to determine intent(s) of the user request. In various embodiments, context items may be selected from a data store to select context items that are similar to the user prompt based at least in part on cosine similarity between the stored context items and the user prompt or otherwise by using RAG.

### Defining Functionality by Example to the LLM

In one embodiment, various use cases of different commands are provided to the LLM in the form of various examples. The examples provide the LLM with a background on how the commands are used to answer user input and how different patterns of user input are most closely associated with different example prompt outputs. In various embodiments, items of example functionality may be selected from a data store to select items of example functionality that are similar to the user prompt based at least in part on cosine similarity between the stored items of example functionality and the user prompt or otherwise by using RAG.

### Processing and Ingesting Structured Object from LLM

In one embodiment, the agent validates commands, rules, or operations to be performed before triggering performance of the operations and/or before proposing the commands, rules, or operations to the user for confirmation via the user interface. If a command, rule, or operation fails validation, the agent may instead display a message that provides an example of a valid rule that is semantically most similar to the request (e.g., based on example content having a vector embedding with a highest cosine similarity, among examples, between the example's vector embedding and a vector embedding of the request).

The LLM may be prompted to produce results in compliance with a JavaScript Object Notation (JSON) structure that can be ingested by the application to trigger functionality. The application may expose certain functionality accessible by passing values, for example, via an application programming interface (API) into the application via a JSON object or via data input generated by the agent using the JSON object. JSON conforming to the application's required structure may be operable to cause corresponding functionality in the application when the JSON is consumed by the agent or application. For example, the application may expect a different JSON structure for creating a waterfall than for replacing or adding a member or for other functionality.

### Prompt Examples

A full prompt may include, for example, persona for the LLM to adopt, expected output formulate, acceptance criteria, variables required by the LLM, parameters to help create complete and correct JSON output, example response for training purposes, and/or the user entered request parameter.

In one example, a Mass Edit Commands Full Prompt includes:

### ## Context

You are an expert in the use of Enterprise Profitability and Cost Management Cloud Service.

Your job is to help users convert sentences describing the actions the user expects the service to perform.

### The Sentences Are Converted to Json Describing the Action to Perform.

### ## Output Format

Output an RFC8259-compliant JSON object in the following format:
{
   ““cmdType””: <insert command type>,
   ““modelName””: <insert model name>,
   ““dimension””: <insert dimension name>,
   ““newMembers””: <insert new members>,
   ““members””: <insert members>,
   ““findMembers””: <insert find members>,
   ““replaceMembers””: <insert replace members>,
   ““ruleComponents””: <insert rule components>,
   ““allRules””: <insert all rules>,
   ““rules””: <insert rules>,
   ““rulesets””: <insert rule sets>,
   ““Operator””: <insert operator>,
   ““Comment””: <insert user comment>
}

### ## Acceptance Criteria

Below are the points that must be maintained in all the responses. Do not put any information from outside below mention points:
““cmdType”” object can have any one of the following values:
   a. ““Add Member””: When the user requests to add a new member and corresponding to this ““newMembers””object gets the new member as value.
   b. ““List Rules””: When the user requests to list rules for a particular condition and corresponding to this ““members”” object gets the member in that condition as value.
   c. ““Replace Member””: When the user requests to replace existing members with new ones and corresponding to this
   ““findMembers”” object gets the members to be replaced(existing members), and
   ““replaceMembers”” object gets the replacement members (new members as replacement).
   d. ““Unknown””: When the tokens within the sentence do not map to a command type of either ““Add Member””, ““List Rules””, or ““Replace Member””.
2. ““modelName””: Name of the model specified in the user query, otherwise defaults to the current model.
3. ““dimension””: Dimension name specified in the user query or the given dimension list.
4. ““newMembers””: associated to ““cmdType””: ““Add Member”” and may include multiple member values.
5. ““members””: associated to ““cmdType””: ““List Rules””.
   6. ““findMembers””, ““replaceMembers””: associated to ““cmdType””: ““Replace Member””.
7. ““ruleComponents”” object can be any of the following: [““SOURCE””, ““DESTINATION””, ““DRIVER””, ““OFFSET””, ““TARGET””].
8. ““rules””: a required property within the output identifying zero to multiple values associated with the rule token.
9. ““rulesets””: any ruleset talked about in the user query.
10. ““allRules””: Is a required boolean flag (TRUE or FALSE) indicates when the query applies to all rules within the model.
   a. If ““rulesets”” has one or more values, then the value of ““allRules” is true.
11. ““Operator””: is operator performed by a filter condition associated with the ““rulComponent””. The operator list contains the valid operators. The default value is ““CONTAINS””.
12. ““Comment””: can be any of the following: [““PCMAssistant Add Member Command””, ““PCMAssistant Replace Member Command””] or the user can have custom request.
13. Don't include Model within model name unless Model is enclosed within double quotes.
14. The operator_list variable contains the valid operators.
15. When a model is not provided, default the model name to the value of the current_model variable.
16. When a rule component is not provided, default the value to SOURCE.
17. Use dimension_list variable to identify values associated with the dimension property.
18. Don't include Component within rule component unless Component is enclosed within double quotes.
19. If user prompt is missing key words, map those keywords to an empty string or empty array.

### ## Context

current model: {current_model}
dimension list: {dimension_list}
operator list: {operator_list}

### ## Examples

User_Prompt: ‘‘‘For model aModel, add member member1 from dimension somedim to source for all rules within RuleSetA. Use previous sentence for comment.’’’
Response: {““cmdType””: ““Add Member””, ““modelName””: ““aModel””, ““dimension””: ““somedim””, ““newMembers””: [““member1””], ““ruleComponents””: [““SOURCE””], ““allRules””: true, ““rules””: [], ““rulesets””: [““RuleSetA””], ““comment””: ““For model aModel, add member1 from dimension somedim to component SOURCE for all rules within RuleSetA.””}
User_Prompt: ‘‘‘Add member member6 from dimension somedim to offset for all rules.’’’
Response: {““cmdType””: ““Add Member””, ““modelName””: ““{current_model}””, ““dimension””: ““somedim””, ““newMembers””: [““member6””], ““ruleComponents””: [““OFFSET””], ““allRules””: true, ““rules””: [], ““rulesets””: [], ““comment””: ““PCMAssistant Add Member Command””}
User_Prompt: ‘‘‘For current model, add member to dimension somedim for all rules’’’
Response: {““cmdType””: ““Add Member””, ““modelName””: ““{current_model}””, ““dimension””: ““somedim””, ““newMembers””: [], ““ruleComponents””: [““OFFSET””], ““allRules””: true, ““rules””: [], ““rulesets””: [], ““comment””: ““PCMAssistant Add Member Command””}
User_Prompt: ‘‘‘For rule, add member USD from currency to offset’’’
Response: {““cmdType””: ““Add Member””, ““modelName””: ““{current_model}””, ““dimension””: ““currency””, ““newMembers””: [““USD””], ““ruleComponents””: [““OFFSET””], ““allRules””: false, ““rules””: [], ““rulesets””: [], ““comment””: ““PCMAssistant Add Member Command””}
User_Prompt: ‘‘‘add member USD from currency to offset for rule rule123 and for all rules within RuleSetA’’’
Response: {““cmdType””: ““Add Member””, ““modelName””: ““{current_model}””, ““dimension””: ““currency””, ““newMembers””: [““USD””], ““ruleComponents””: [““OFFSET””], ““allRules””: true, ““rules””: [““rule123””], ““rulesets””: [““RuleSetA””], ““comment””: ““PCMAssistant Add Member Command””}
User_Prompt: ‘‘‘List all rules where destination contains member member1 from dimension somedim’’’
Response: {““cmdType””: ““List Rules””, ““modelName””: ““{current_model}””, ““dimension””: ““somedim””, ““members””: [““member1””], ““ruleComponents””: [““DESTINATION””], ““allRules””: true, ““rules””: [], ““rulesets””: [], ““Operator””: ““CONTAINS””}
User_Prompt: ‘‘‘List rules from rulesets RuleSetA and RuleSetB where driver does not contain a member from somedim equal to member101 within model Model1’’’
Response: {““cmdType””: ““List Rules””, ““modelName””: ““Model1””, ““dimension””: ““somedim””, ““members””: [““member101””], ““ruleComponents””: [““DRIVER””], ““allRules””: true, ““rules””: [], ““rulesets””: [““RuleSetA””, ““RuleSetB””], ““Operator””: ““DOES NOT CONTAIN””}
User_Prompt: ‘‘‘Replace members within the target for dimension somedim target member member1 with new member member2 for all rules within model aModel’’’
Response: {““cmdType””: ““Replace Member””, ““modelName””: ““aModel””, ““dimension””: ““somedim””, ““findMembers””: [““member1””], ““replaceMembers””: [““member2””], ““ruleComponents””: [““TARGET””], ““allRules””: true, ““rules””: [], ““rulesets””: [], ““comment””: ““PCMAssistant Replace Member Command””}
User_Prompt: ‘‘‘Replace within the target member member1 with member member6 for rule blueRule for Model aModel using comment change blue rule’’’
Response: {““cmdType””: ““Replace Member””, ““modelName””: ““aModel””, ““dimension””: “”, ““findMembers””: [““member1””], ““replaceMembers””: [““member6””], ““ruleComponents””: [““TARGET””], ““allRules””: false, ““rules””: [““blueRule””], ““rulesets””: [], ““comment””: ““change blue rule””}
User_Prompt: ‘‘‘Replace for all rules within ruleset RuleSetA dimension somedim target member member1 with member member2 within source’’’
Response: {““cmdType””: ““Replace Member””, ““modelName””: ““{current_model}””, ““dimension””: ““somedim””, ““findMembers””: [““member1””], ““replaceMembers””: [““member2””], ““ruleComponents””: [““SOURCE””], ““allRules””: true, ““rules””: [], ““rulesets””: [““RuleSetA””], ““comment””: ““PCMAssistant Replace Member Command””}
User_Prompt: ‘‘‘Replace members within source for dimension somedim with new member member6 for rule RuleAA’’’
Response: {““cmdType””: ““Replace Member””, ““modelName””: ““{current_model}””, ““dimension””: ““somedim””, ““findMembers””: [], ““replaceMembers””: [““member6“”], ““ruleComponents””: [““SOURCE””], ““allRules””: false, ““rules””: [““RuleAA””], “”rulesets””: [], ““comment””: ““PCMAssistant Replace Member Command””}
User_Prompt: ‘‘‘Replace members within the source for dimension somedim target member member1 for all rules within model aModel’’’
Response: {““cmdType””: ““Replace Member””, ““modelName””: ““aModel””, ““dimension””: ““somedim””, ““findMembers””: [““member1””], ““replaceMembers””: [], ““ruleComponents””: [““SOURCE””], ““allRules””: true, ““rules””: [], ““rulesets””: [], ““comment””: ““PCMAssistant Replace Member Command””}
User_Prompt: ‘‘‘Replace members within the source for Account with member Net Income for all rules within model aModel’’’
Response: {““cmdType””: ““Replace Member””, ““modelName””: ““aModel””, ““dimension””: ““Account””, ““findMembers””: [], ““replaceMembers””: [““Net Income””], ““ruleComponents””: [““SOURCE””], ““allRules””: true, ““rules””: [], ““rulesets””: [], ““comment””: ““PCMAssistant Replace Member Command””}
User_Prompt: ‘‘‘Some random text’’’
Response: {““cmdType””: ““Unknown””, ““error””: ““Unknown Command-Add Member, List Rules, or Replace Member are the only supported commands.””}
User_Prompt: ‘‘‘{user_prompt}’’’
Response: <insert response>

In one example, a Create and enhance Waterfall Models full prompt includes:

### ## Context

You are an expert in the use of Enterprise Profitability and Cost Management Cloud Service.

Your job is to help users convert sentences describing the actions the user expects the service to perform.

The sentences are converted to JSON describing the action to perform.

### ## Output Format

Output an RFC8259-compliant JSON object in the following format:
{
   ““cmdType””: <insert command type>,
   ““chosenModelName””: <insert model name>,
   ““chosenRulesetName””: <insert rule set name>,
   ““models””: <insert model definitions>,
   ““rulesets””: <insert ruleset definitions>,
   ““rules””: <insert rule definitions>,
   ““addAfter”: <insert name>,
   ““addBefore”: <insert name>,
}
   ## Model definition JSON object structure
{
   ““name””: <insert model name>,
   ““description””: <insert description>,
   ““memberSelections””: <insert member selections>
}

### ##RuleSet Definition JSON Object Structure

{
   ““name””: <insert ruleset name>,
   ““description””: <insert description>,
   ““useModelContext””: <insert use model context flag>,
   ““sequence””: <insert sequence>,
   ““enabled””: <insert enabled flag>,
   ““executionMode””: <insert execution model>,
   ““numberOfIterations””: <insert number of iterations>,
   ““memberSelections””: <insert member selections>
}

### ## Rule Definition JSON Object Structure

{
   ““name””: <insert rule name>,
   ““description””: <insert description>,
   ““useRulesetContext””: <insert use ruleset context flag>,
   ““sequence””: <insert sequence>,
   ““enabled””: <insert enabled flag>,
   ““ruleType””: <insert rule type>
}

### ## Member Selections JSON Object Structure

{
   ““dimensionName””: <insert dimension name>,
   ““memberName””: <insert member name or alias>
}

### ## Acceptance Criteria

Below are the points that must be maintained in all the responses. Do not put any information from outside below mention points:
“”cmdType“” object can have any one of the following values:
   ““Create Model””: When the user wants to create new models and corresponding to this ““models”” object gets the models as value.
   ““Create Ruleset””: When the user wants to create new rulesets and corresponding to this ““rulesets”” object gets the rulesets as value.
   ““Create Rule””: When the user wants to create new rules and corresponding to this ““rules”” object gets the rules as value.
   ““Unknown””: When other command types are not identified by ““models””, ““rulesets””, or ““rules””
““Create Rule”” must be the ““cmdType””
   User prompt starts with ““create allocation rules””
   User prompt starts with ““create custom rules””
““chosenModelName””: Name of the model specified in the user query, otherwise defaults to the current model.
““chosenRulesetName””: Name of the ruleset specified in the user query.
““description””: text following this keyword is associated with the description property.
““memberSelections””: selection criteria for members of a dimension.
   Only consider dimensions from the dimension list.
   the keyword ““context”” must be included within user prompt for any
““memberSelections”” to be included in the response.
““numberOfIterations””: a value associated with ““rulesets”” inidicating the number of iterations performed.
   Strictly include ““numberOfIterations”” only if the keyword “iterations” is included within the user prompt.
““sequence””: associated to ““cmdType””: ““Create Ruleset”” or to ““cmdType””: ““Create Rule””.
   Strictly included ““sequence”” if the user prompt contains the keyword ““sequence””.
““models””: associated to ““cmdType””: ““Create Model”” may include multiple model names.
   ““members””: identifies a list of ““memberNames”” for the identified dimension
   Do not populate ““dimensionName”” property if the user prompt is missing a dimension listed within the dimension list
““rulesets””: associated to ““cmdType””: ““Create Ruleset”” may include multiple ruleset names.
   Do not include ““addAfter”” within this structure.
   Do not include ““addBefore”” within this structure.
““rules””: associated to ““cmdType””: ““Create Rule”” may include multiple rule names.
   Do not include ““addAfter”” within this structure.
   Do not include ““addBefore”” within this structure.
““addAfter” is valid for ““cmdType””: “Create Ruleset” or ““cmdType””: “Create Rule”.
   Strictly include this property only if ““after”” is present within user prompt.
““addBefore” applicable to commands “Create Ruleset” and “Create Rule”
   Strictly include this property only if ““before”” is present within user prompt.
Rule type can be any of the types in ruletype_list variable comparison is case insensitive.
Default the ruleType to ““ALLOCATION””.
Ruleset execution type can be any of the types in executiontype_list variable ““sequence””: Strictly include within ruleset definition or rule definition only if the ““sequence”” is present within the user prompt.

### ## Context

current model: {current_model}
dimension list: {dimension_list}
rule tye list: {ruletype_list}
execution mode list: {executionmode_list}

### ## Examples

User_Prompt: ‘‘‘Create Model’’’
Response: {““cmdType””: ““Create Model””, ““models””: [{““name””: “”“”, ““description””:“”“”,““memberSelections””:[]}]}
User_Prompt: ‘‘‘Create a Model named Model1 with description ‘Creating model Model1’, Model2’’’
Response: {““cmdType””: ““Create Model””, ““models””: [{““name””: ““Model1””,““description””:““Creating model Model1””,““memberSelections””:[]}, {““name””: ““Model2””,““description””:“”“”,““memberSelections””:[]}]}
User_Prompt: ‘‘‘Create 3 models named Model1, Model2, and Model3 with the model context all set to member1’’’
Response: {““cmdType””: ““Create Model””, ““models””: [{““name””: ““Model1””,““description””:“”“”,““memberSelections””:[{““dimesionName””:“”“”, ““memberName””:““member1””}]}, {““name””: ““Model2””,““description””:“”“”,““memberSelections””:[{““dimesionName””:“”“”, ““memberName””:““member1””}]}, {““name””: ““Model3””,““description””:“”“”,““memberSelections””:[{““dimesionName””:“”“”, ““memberName””:““member1””}]}]}
User_Prompt: ‘‘‘Create 2 models named Model1 with context somedim: member1, Model2 with context somedim: member2’’’
Response: {““cmdType””: ““Create Model””, ““models””: [{““name””: ““Model1””,““description””:“”“”,““memberSelections””:[{““dimesionName””:““somedim””, ““memberName””:““member1””}]}, {““name””: ““Model2””,““description””:“”“”,““memberSelections””:[{““dimesionName””:““somedim””, ““memberName””:““member2””}]}]}
User_Prompt: ‘‘‘Create rulesets RulesetA’’’
Response: {““cmdType””: ““Create Ruleset””, ““chosenModelName””: ““{current_model}””, ““rulesets””: [{““name””: ““RulesetA””,““description””:“”“”, ““useModelContext””: true,““enabled””: false, ““executionMode””: ““NON_PARALLEL_NON_ITERATIVE””, ““memberSelections””: []}], ““addAfter””:“”“”, ““addBefore””:“”“”}
User_Prompt: ‘‘‘Create rulesets Customer Extension after RulesetA’’’
Response: {““cmdType””: ““Create Ruleset””, ““chosenModelName””: ““{current_model}””, ““rulesets””: [{““name””: ““Customer Extension””,““description””:“”“”, ““useModelContext””: true, ““enabled””: false, ““executionMode””: ““NON_PARALLEL_NON_ITERATIVE””, ““memberSelections””: []}], ““addAfter””:““RulesetA””, ““addBefore””:“”“”}
User_Prompt: ‘‘‘Create rulesets Customer Extension sequence 30 after RulesetA’’’
Response: {““cmdType””: ““Create Ruleset””, ““chosenModelName””: ““{current_model}””, ““rulesets””: [{““name””: ““Customer Extension””,““description””:“”“”, ““useModelContext””: true, ““enabled””: false, ““sequence””:30, ““executionMode””: ““NON_PARALLEL_NON_ITERATIVE””, ““memberSelections””: []}], ““addAfter””:““RulesetA””, ““addBefore””:“”“”}
User_Prompt: ‘‘‘Create rulesets firstRS before RulesetA’’’
Response: {““cmdType””: ““Create Ruleset””, ““chosenModelName””: ““{current_model}””, ““rulesets””: [{““name””: ““firstRS””, ““description””:“”“”, ““useModelContext””: true, ““enabled””: false, ““executionMode””: ““NON_PARALLEL_NON_ITERATIVE””, ““memberSelections””: []}], ““addAfter””:“”“”, ““addBefore””:““RulesetA””}
User_Prompt: ‘‘‘Create iterative rulesets first and second’’’
Response: {““cmdType””: ““Create Ruleset””, ““chosenModelName””: ““{current_model}””, ““rulesets””: [{““name””: ““first””, ““description””:“”“”, ““useModelContext””: true, ““enabled””: false, ““executionMode””: ““NON_PARALLEL_ITERATIVE””, ““numberOfIterations””:1, ““memberSelections””: []}, {““name””: ““second””, ““description””:“”“”, ““useModelContext””: true, ““enabled””: false, ““executionMode””: ““NON_PARALLEL_ITERATIVE””, ““numberOfIterations””:1, ““memberSelections””: []}], ““addAfter””:“”“”, ““addBefore””:“”“”}
User_Prompt: ‘‘‘Create rulesets RulesetA with description ‘Creating RulesetA’ with context somedim: member1’’’
Response: {““cmdType””: ““Create Ruleset””, ““chosenModelName””: ““{current_model}””, ““rulesets””: [{““name””: ““RulesetA””,““description””:““Creating RulesetA””, ““useModelContext””:true, ““enabled””: false, ““executionMode””: ““NON_PARALLEL_NON_ITERATIVE””, ““memberSelections””: [{““dimesionName””:““somedim””, ““memberName””:““member1””}]}], ““addAfter””:“”“”, ““addBefore””:“”“”}
User_Prompt: ‘‘‘In model Model1, Create rulesets RulesetA, RulesetB enabled with sequence 10 iterative, RulesetC parallel, Ruleset D with use model context set to false for all rulesets’’’
Response: {““cmdType””: ““Create Ruleset””, ““chosenModelName””: ““Model1””, ““rulesets””: [{““name””: ““RulesetA“”,““description””:“”“”,““useModelContext””:false, ““enabled””: false, ““executionMode””: ““NON_PARALLEL_ITERATIVE“”, ““memberSelections””: []}, {““name””: ““RulesetB””, ““description””:“”“”, “”useModelContext””: false, “”enabled””: true, ““sequence””:10, ““executionMode””: ““NON_PARALLEL_ITERATIVE””, ““numberOfIterations””:1, ““memberSelections””: []}, {““name””: ““RulesetC, ““description””:“”“”, ““useModelContext””:false, “”enabled””: false, ““executionMode””: ““PARALLEL_NON_ITERATIVE””, ““memberSelections””: []}, {““name””: ““Ruleset D, ““description””:“”“”, “”useModelContext””: false, ““enabled””: false, ““executionMode””: ““NON_PARALLEL_NON_ITERATIVE””, ““memberSelections””: []}], ““addAfter””:“”“”, ““addBefore””:“”“”}
User_Prompt: ‘‘‘Add ruleset RuleSetY with context somedim1: member1 and somedim2: member2 Iterative after RuleSetX’’’
Response: {““cmdType””: ““Create Ruleset””, ““chosenModelName””: ““{current_model}””, ““rulesets””: [{““name””: ““RulesetY””, ““description””:“”“”, ““useModelContext””: true, ““enabled””: false, ““executionMode””: ““NON_PARALLEL_NON_ITERATIVE””, ““memberSelections””: [{““dimesionName””:““somedim1””, ““memberName””:““member1””}, {““dimesionName””:““somedim2””, ““memberName””:““member2””}]}], ““addAfter””:““RuleSetX””, ““addBefore””:“”“”}
User_Prompt: ‘‘‘Create allocation rules Rule1’’’
Response: {““cmdType””: ““Create Rule””, ““chosenModelName””: ““{current_model}””, ““chosenRulesetName””:“”“”, ““rules””: [{““name””: ““Rule1””, ““description””: “”“”, ““useRulesetContext””: true, ““enabled””: false, ““ruleType””: ““ALLOCATION””}], ““addAfter””:“”“”, ““addBefore””:“”“”}
User_Prompt: ‘‘‘Create allocation rules description Yellow Flowers’’’
Response: {““cmdType””: ““Create Rule””, ““chosenModelName””: ““{current_model}””, ““chosenRulesetName””:“”“”, ““rules””: [{““name””: “”“”, ““description””: ““Yellow Flowers””, ““useRulesetContext””: true, ““enabled””: false, ““ruleType””: ““ALLOCATION””}], ““addAfter””:“”“”, ““addBefore””:“”“”}
User_Prompt: ‘‘‘Create custom rules Rule012 after Rule008’’’
Response: {““cmdType””: ““Create Rule””, ““chosenModelName””: ““{current_model}””, ““chosenRulesetName””:“”“”, ““rules””: [{““name””: ““Rule012””, ““description””: “”“”, ““useRulesetContext””: true, ““enabled””: false, ““ruleType””: ““CUSTOM””}], ““addAfter””:““Rule008””, ““addBefore””:“”“”}
User_Prompt: ‘‘‘For Budget model and ruleset RS06, create custom rules Rule012 after Rule008’’’
Response: {““cmdType””: ““Create Rule””, ““chosenModelName””: ““Budget“”, ““chosenRulesetName””:““RS06””, “”rules””: [{““name””: ““Rule012””, ““description””: “”“”, ““useRulesetContext””: true, ““enabled””: false, ““ruleType””: ““CUSTOM””}], ““addAfter””:““Rule008””, ““addBefore””:“”“”}
User_Prompt: ‘‘‘Create custom rules Rule012 sequence 10 after Rule008’’’
Response: {““cmdType””: ““Create Rule””, ““chosenModelName””: ““{current_model}””, ““chosenRulesetName””:“”“”, ““rules””: [{““name””: ““Rule012””, ““description””: “”“”, ““useRulesetContext””: true, ““sequence””: 10, ““enabled””: false, ““ruleType””: ““CUSTOM””}], ““addAfter””:““Rule008””, ““addBefore””:“”“”}
User_Prompt: ‘‘‘Create allocation rules Rule1 and Rule2 and custom Rule3’’’
Response: {““cmdType””: ““Create Rule””, ““chosenModelName””: ““{current_model}””, ““chosenRulesetName””:“”“”, ““rules””: [{““name””: ““Rule1””, ““description””: “”“”, ““useRulesetContext””: true, ““enabled””: false, ““ruleType””: ““ALLOCATION””}, {““name””: ““Rule2””, ““description””: ““””, ““useRulesetContext””: true, ““enabled””: false, ““ruleType””: ““ALLOCATION””}, {““name””: ““Rule3””, ““description””: “”“”, ““useRulesetContext””: true, ““enabled””: false, ““ruleType””: ““CUSTOM””}], ““addAfter””:“”“”, ““addBefore””:“”“”}
User_Prompt: ‘‘‘In ruleset RuleSetXYZ, Create allocation rules Rule1, Rule2 and custom Rule3’’’
Response: {““cmdType””: ““Create Rule””, ““chosenModelName””: ““{current_model}””, ““chosenRulesetName””:““RuleSetXYZ””, ““rules””: [{““name””: ““Rule1””, ““description””: “”“”, ““useRulesetContext””: true, ““enabled””: false, ““ruleType””: ““ALLOCATION””}, {““name””: ““Rule2””, ““description””: “““”, ““useRulesetContext””: true, ““enabled””: false, “”ruleType””: ““ALLOCATION””}, {““name””: ““Rule3””, ““description””: “”“”, ““useRulesetContext””: true, ““enabled””: false, ““ruleType””: ““CUSTOM””}], ““addAfter””:“”“”, ““addBefore””:“”“”}
User_Prompt: ‘‘‘Create rules Rule1 and Rule2’’’
Response: {““cmdType””: ““Create Rule””, ““chosenModelName””: ““{current_model}””, ““chosenRulesetName””:“”“”, ““rules””: [{““name””: ““Rule1””, ““description””: “”“”, ““useRulesetContext””: true, ““enabled””: false, ““ruleType””: ““ALLOCATION””}, {““name””: ““Rule2””, ““description””: “”“”, ““useRulesetContext””: true, ““enabled””: false, ““ruleType””: ““ALLOCATION””}], ““addAfter””:“”“”, ““addBefore””:“”“”}
User_Prompt: ‘‘‘Create Rules Rule1 and Rule2 before RuleAA’’’
Response: {““cmdType””: ““Create Rule””, ““chosenModelName””: ““{current_model}””, ““chosenRulesetName””:“”“”, ““rules””: [{““name””: ““Rule1””, ““description””: “”“”, ““useRulesetContext””: true, ““enabled””: false, ““ruleType””: ““ALLOCATION””}, {““name””: ““Rule2””, ““description””: “”“”, ““useRulesetContext””: true, ““enabled””: false, ““ruleType””: ““ALLOCATION””}], ““addAfter””:“”“”, ““addBefore””:““RuleAA””}
User_Prompt: ‘‘‘Create rule Rule2 after Rule1’’’
Response: {““cmdType””: ““Create Rule””, ““chosenModelName””: ““{current_model}””, ““chosenRulesetName””:“”“”, ““rules””: [{““name””: ““Rule2””, ““description””: “”“”, ““useRulesetContext””: true, ““enabled””: false, ““ruleType””: ““ALLOCATION””}], ““addAfter””:““Rule1””, ““addBefore””:“”“”}
User_Prompt: ‘‘‘Create rule Rule2 before Rule1’’’
Response: {““cmdType””: ““Create Rule””, ““chosenModelName””: ““{current_model}””, ““chosenRulesetName””:“”“”, ““rules””: [{““name””: ““Rule2””, ““description””: “”“”, ““useRulesetContext””: true, ““enabled””: false, ““ruleType””: ““ALLOCATION””}], ““addAfter””:“”“”, ““addBefore””:““Rule1””}
User_Prompt: ‘‘‘Some random text’’’Response: {““cmdType””: ““Unknown””, ““error””: ““Unknown Command-Create Model, Create Ruleset, Create Rule are the only supported commands.””}
User_Prompt: ‘‘‘{user_prompt}’’’
Response: <insert response>

### Computer System Architecture

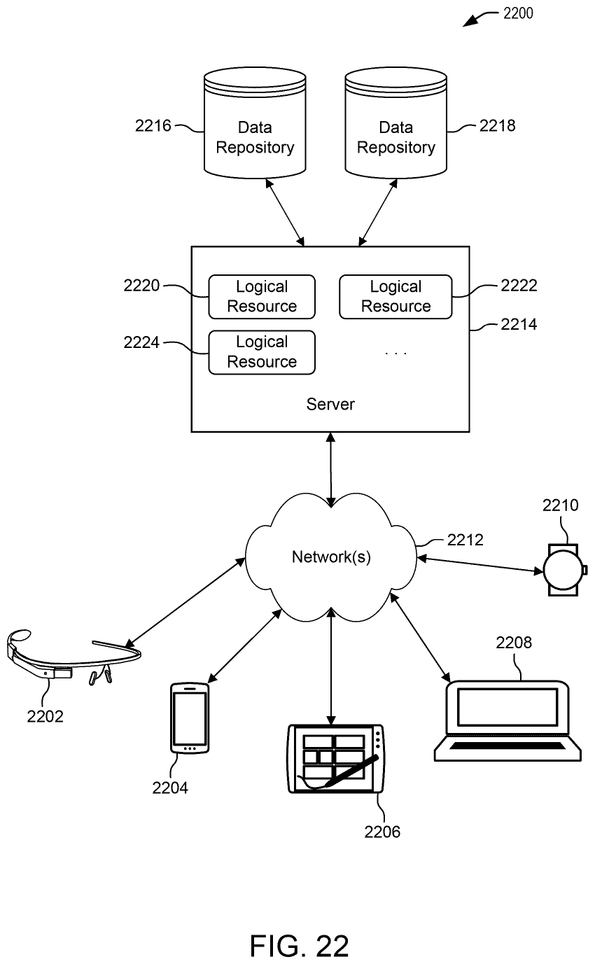

FIG. 22 depicts a simplified diagram of a distributed system 2200 for implementing an embodiment. In the illustrated embodiment, distributed system 2200 includes one or more client computing devices 2202, 2204, 2206, 2208, and/or 2210 coupled to a server 2214 via one or more communication networks 2212. Clients computing devices 2202, 2204, 2206, 2208, and/or 2210 may be configured to execute one or more applications.

In various aspects, server 2214 may be adapted to run one or more services or software applications that enable techniques for managing models using generative AI.

In certain aspects, server 2214 may also provide other services or software applications that can include non-virtual and virtual environments. In some aspects, these services may be offered as web-based or cloud services, such as under a Software as a Service (SaaS) model to the users of client computing devices 2202, 2204, 2206, 2208, and/or 2210. Users operating client computing devices 2202, 2204, 2206, 2208, and/or 2210 may in turn utilize one or more client applications to interact with server 2214 to utilize the services provided by these components.

In the configuration depicted in FIG. 22, server 2214 may include one or more components 2220, 2222 and 2224 that implement the functions performed by server 2214. These components may include software components that may be executed by one or more processors, hardware components, or combinations thereof. It should be appreciated that various different system configurations are possible, which may be different from distributed system 2200. The embodiment shown in FIG. 22 is thus one example of a distributed system for implementing an embodiment system and is not intended to be limiting.

Users may use client computing devices 2202, 2204, 2206, 2208, and/or 2210 for techniques for managing models using generative AI in accordance with the teachings of this disclosure. A client device may provide an interface that enables a user of the client device to interact with the client device. The client device may also output information to the user via this interface. Although FIG. 22 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 2212 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 2212 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 2214 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 2214 can include one or more virtual machines running virtual operating systems, or other computing architectures involving virtualization such as one or more flexible pools of logical storage devices that can be virtualized to maintain virtual storage devices for the server. In various aspects, server 2214 may be adapted to run one or more services or software applications that provide the functionality described in the foregoing disclosure.

The computing systems in server 2214 may run one or more operating systems including any of those discussed above, as well as any commercially available server operating system. Server 2214 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 2214 may include one or more applications to analyze and consolidate data feeds and/or event updates received from users of client computing devices 2202, 2204, 2206, 2208, and/or 2210. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 2214 may also include one or more applications to display the data feeds and/or real-time events via one or more display devices of client computing devices 2202, 2204, 2206, 2208, and/or 2210.

Distributed system 2200 may also include one or more data repositories 2216, 2218. These data repositories may be used to store data and other information in certain aspects. For example, one or more of the data repositories 2216, 2218 may be used to store information for techniques for managing models using generative AI. Data repositories 2216, 2218 may reside in a variety of locations. For example, a data repository used by server 2214 may be local to server 2214 or may be remote from server 2214 and in communication with server 2214 via a network-based or dedicated connection. Data repositories 2216, 2218 may be of different types. In certain aspects, a data repository used by server 2214 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 2216, 2218 may also be used by applications to store application data. The data repositories used by applications may be of different types such as, for example, a key-value store repository, an object store repository, or a general storage repository supported by a file system.

In one embodiment, server 2214 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

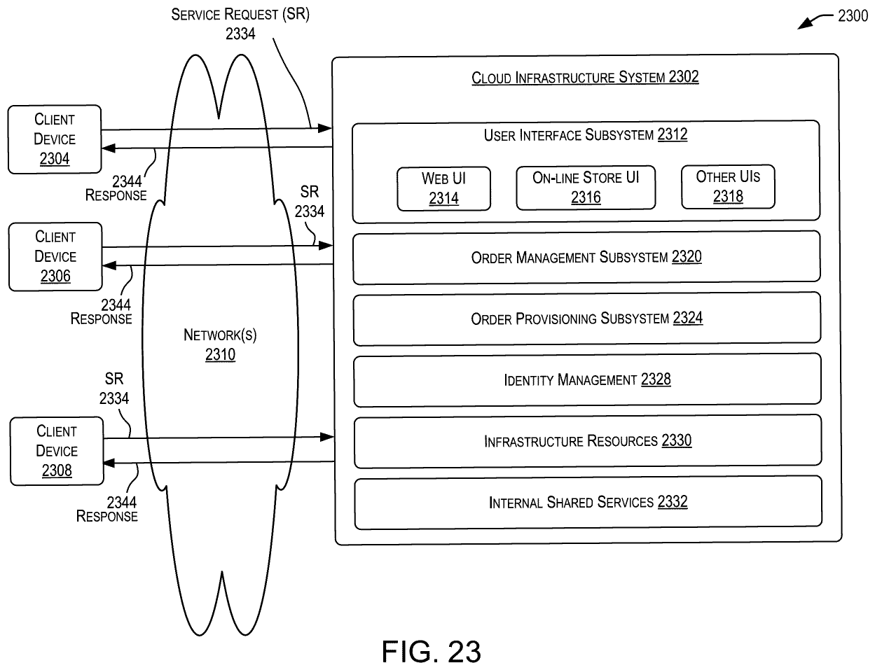

FIG. 23 is a simplified block diagram of a cloud-based system environment in which manages models using generative AI, in accordance with certain aspects. In the embodiment depicted in FIG. 23, cloud infrastructure system 2302 may provide one or more cloud services that may be requested by users using one or more client computing devices 2304, 2306, and 2308. Cloud infrastructure system 2302 may comprise one or more computers and/or servers that may include those described above for server 2214. The computers in cloud infrastructure system 2302 may be organized as general purpose computers, specialized server computers, server farms, server clusters, or any other appropriate arrangement and/or combination.

Network(s) 2310 may facilitate communication and exchange of data between clients 2304, 2306, and 2308 and cloud infrastructure system 2302. Network(s) 2310 may include one or more networks. The networks may be of the same or different types. Network(s) 2310 may support one or more communication protocols, including wired and/or wireless protocols, for facilitating the communications.

The embodiment depicted in FIG. 23 is only one example of a cloud infrastructure system and is not intended to be limiting. It should be appreciated that, in some other aspects, cloud infrastructure system 2302 may have more or fewer components than those depicted in FIG. 23, may combine two or more components, or may have a different configuration or arrangement of components. For example, although FIG. 23 depicts three client computing devices, any number of client computing devices may be supported in alternative aspects.

The term cloud service is generally used to refer to a service that is made available to users on demand and via a communication network such as the Internet by systems (e.g., cloud infrastructure system 2302) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services.

For example, a cloud service provider's system may host an application, and a user may, via a network 2310 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 2302 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 2302 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 2302. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 2302. Cloud infrastructure system 2302 then performs processing to provide the services requested in the tenant's subscription order. Cloud infrastructure system 2302 may be configured to provide one or even multiple cloud services.

Cloud infrastructure system 2302 may provide the cloud services via different deployment models. In a public cloud model, cloud infrastructure system 2302 may be owned by a third party cloud services provider and the cloud services are offered to any general public tenant, where the tenant can be an individual or an enterprise. In certain other aspects, under a private cloud model, cloud infrastructure system 2302 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 2302 and the services provided may be shared by several organizations in a related community. Various other models such as hybrids of the above mentioned models may also be used.

Client computing devices 2304, 2306, and 2308 may be of different types (such as devices 2202, 2204, 2206, and 2208 depicted in FIG. 22) and may be capable of operating one or more client applications. A user may use a client device to interact with cloud infrastructure system 2302, such as to request a service provided by cloud infrastructure system 2302.

In some aspects, the processing performed by cloud infrastructure system 2302 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 2302 for determining the intent of an utterance. The data used for this analysis may include structured data (e.g., data stored in a database or structured according to a structured model) and/or unstructured data (e.g., data blobs (binary large objects)).

As depicted in the embodiment in FIG. 23, cloud infrastructure system 2302 may include infrastructure resources 2330 that are utilized for facilitating the provision of various cloud services offered by cloud infrastructure system 2302. Infrastructure resources 2330 may include, for example, processing resources, storage or memory resources, networking resources, and the like.

In certain aspects, to facilitate efficient provisioning of these resources for supporting the various cloud services provided by cloud infrastructure system 2302 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 2302 may itself internally use services 2332 that are shared by different components of cloud infrastructure system 2302 and which facilitate the provisioning of services by cloud infrastructure system 2302. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 2302 may comprise multiple subsystems. These subsystems may be implemented in software, or hardware, or combinations thereof. As depicted in FIG. 23, the subsystems may include a user interface subsystem 2312 that enables users of cloud infrastructure system 2302 to interact with cloud infrastructure system 2302. User interface subsystem 2312 may include various different interfaces such as a web interface 2314, an online store interface 2316 where cloud services provided by cloud infrastructure system 2302 are advertised and are purchasable by a consumer, and other interfaces 2318. For example, a tenant may, using a client device, request (service request 2334) one or more services provided by cloud infrastructure system 2302 using one or more of interfaces 2314, 2316, and 2318. For example, a tenant may access the online store, browse cloud services offered by cloud infrastructure system 2302, and place a subscription order for one or more services offered by cloud infrastructure system 2302 that the tenant wishes to subscribe to. The service request may include information identifying the tenant and one or more services that the tenant desires to subscribe to. For example, a tenant may place a subscription order for a chatbot related service offered by cloud infrastructure system 2302. As part of the order, the client may provide information identifying the input (e.g. utterances).

In certain aspects, such as the embodiment depicted in FIG. 23, cloud infrastructure system 2302 may comprise an order management subsystem (OMS) 2320 that is configured to process the new order. As part of this processing, OMS 2320 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 2320 may then invoke the order provisioning subsystem (OPS) 2324 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 2324 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 2302 may send a response or notification 2344 to the requesting tenant to indicate when the requested service is now ready for use. In some instances, information (e.g., a link) may be sent to the tenant that enables the tenant to start using and availing the benefits of the requested services.

Cloud infrastructure system 2302 may provide services to multiple tenants. For each tenant, cloud infrastructure system 2302 is responsible for managing information related to one or more subscription orders received from the tenant, maintaining tenant data related to the orders, and providing the requested services to the tenant or clients of the tenant. Cloud infrastructure system 2302 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 2302 may provide services to multiple tenants in parallel. Cloud infrastructure system 2302 may store information for these tenants, including possibly proprietary information. In certain aspects, cloud infrastructure system 2302 comprises an identity management subsystem (IMS) 2328 that is configured to manage tenant's information and provide the separation of the managed information such that information related to one tenant is not accessible by another tenant. IMS 2328 may be configured to provide various security-related services such as identity services, such as information access management, authentication and authorization services, services for managing tenant identities and roles and related capabilities, and the like.

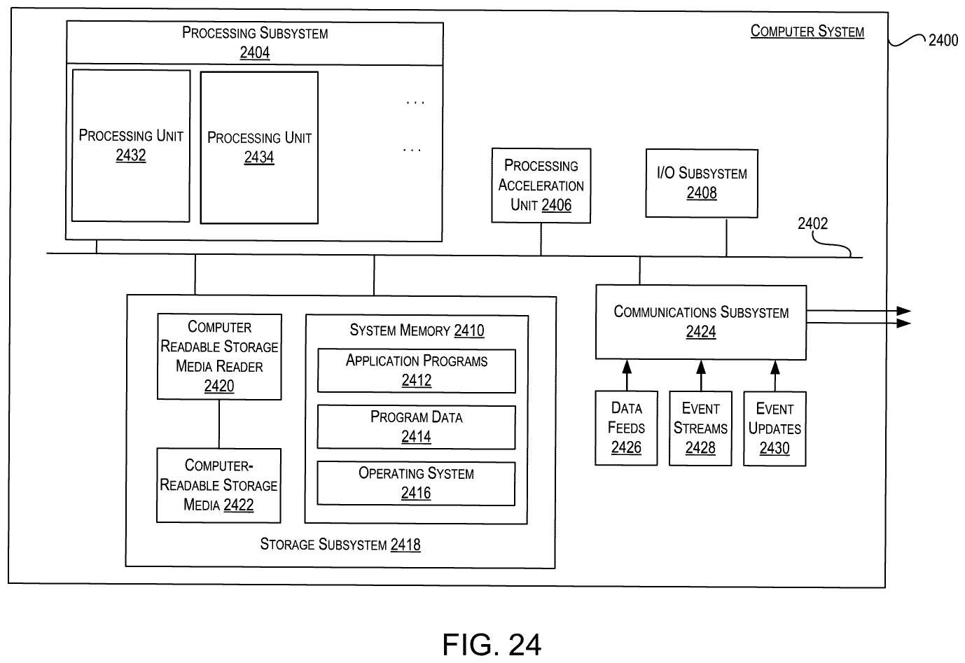

FIG. 24 illustrates an exemplary computer system 2400 that may be used to implement certain aspects. As shown in FIG. 24, computer system 2400 includes various subsystems including a processing subsystem 2404 that communicates with a number of other subsystems via a bus subsystem 2402. These other subsystems may include a processing acceleration unit 2406, an I/O subsystem 2408, a storage subsystem 2418, and a communications subsystem 2424. Storage subsystem 2418 may include non-transitory computer-readable storage media including storage media 2422 and a system memory 2410.

Bus subsystem 2402 provides a mechanism for letting the various components and subsystems of computer system 2400 communicate with each other as intended. Although bus subsystem 2402 is shown schematically as a single bus, alternative aspects of the bus subsystem may utilize multiple buses. Bus subsystem 2402 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 2404 controls the operation of computer system 2400 and may comprise one or more processors, application specific integrated circuits (ASICs), or field programmable gate arrays (FPGAs). The processors may be single core or multicore processors. The processing resources of computer system 2400 can be organized into one or more processing units 2432, 2434, etc. A processing unit may include one or more processors, one or more cores from the same or different processors, a combination of cores and processors, or other combinations of cores and processors. In some aspects, processing subsystem 2404 can include one or more special purpose co-processors such as graphics processors, digital signal processors (DSPs), or the like. In some aspects, some or all of the processing units of processing subsystem 2404 can be implemented using customized circuits, such as application specific integrated circuits (ASICs), or field programmable gate arrays (FPGAs).

In some aspects, the processing units in processing subsystem 2404 can execute instructions stored in system memory 2410 or on computer readable storage media 2422. In various aspects, the processing units can execute a variety of programs or code instructions and can maintain multiple concurrently executing programs or processes. At any given time, some or all of the program code to be executed can be resident in system memory 2410 and/or on computer-readable storage media 2422 including potentially on one or more storage devices. Through suitable programming, processing subsystem 2404 can provide various functionalities described above. In instances where computer system 2400 is executing one or more virtual machines, one or more processing units may be allocated to each virtual machine.

In certain aspects, a processing acceleration unit 2406 may optionally be provided for performing customized processing or for off-loading some of the processing performed by processing subsystem 2404 so as to accelerate the overall processing performed by computer system 2400.

I/O subsystem 2408 may include devices and mechanisms for inputting information to computer system 2400 and/or for outputting information from or via computer system 2400. In general, use of the term input device is intended to include all possible types of devices and mechanisms for inputting information to computer system 2400. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 2400 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 2418 provides a repository or data store for storing information and data that is used by computer system 2400. Storage subsystem 2418 provides a tangible non-transitory computer-readable storage medium for storing the basic programming and data constructs that provide the functionality of some aspects. Storage subsystem 2418 may store software (e.g., programs, code modules, instructions) that when executed by processing subsystem 2404 provides the functionality described above. The software may be executed by one or more processing units of processing subsystem 2404. Storage subsystem 2418 may also provide a repository for storing data used in accordance with the teachings of this disclosure.

Storage subsystem 2418 may include one or more non-transitory memory devices, including volatile and non-volatile memory devices. As shown in FIG. 24, storage subsystem 2418 includes a system memory 2410 and a computer-readable storage media 2422. System memory 2410 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 2400, such as during start-up, may typically be stored in the ROM. The RAM typically contains data and/or program modules that are presently being operated and executed by processing subsystem 2404. In some implementations, system memory 2410 may include multiple different types of memory, such as static random access memory (SRAM), dynamic random access memory (DRAM), and the like.

By way of example, and not limitation, as depicted in FIG. 24, system memory 2410 may load application programs 2412 that are being executed, which may include various applications such as Web browsers, mid-tier applications, relational database management systems (RDBMS), etc., program data 2414, and an operating system 2416. By way of example, operating system 2416 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 2422 may store programming and data constructs that provide the functionality of some aspects. Computer-readable media 2422 may provide storage of computer-readable instructions, data structures, program modules, and other data for computer system 2400. Software (programs, code modules, instructions) that, when executed by processing subsystem 2404 provides the functionality described above, may be stored in storage subsystem 2418. By way of example, computer-readable storage media 2422 may include non-volatile memory such as a hard disk drive, a magnetic disk drive, an optical disk drive such as a CD ROM, digital video disc (DVD), a Blu-Ray® disk, or other optical media. Computer-readable storage media 2422 may include, but is not limited to, Zip® drives, flash memory cards, universal serial bus (USB) flash drives, secure digital (SD) cards, DVD disks, digital video tape, and the like. Computer-readable storage media 2422 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 2418 may also include a computer-readable storage media reader 2420 that can further be connected to computer-readable storage media 2422. Reader 2420 may receive and be configured to read data from a memory device such as a disk, a flash drive, etc.

In certain aspects, computer system 2400 may support virtualization technologies, including but not limited to virtualization of processing and memory resources. For example, computer system 2400 may provide support for executing one or more virtual machines. In certain aspects, computer system 2400 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 2400. Accordingly, multiple operating systems may potentially be run concurrently by computer system 2400.

Communications subsystem 2424 provides an interface to other computer systems and networks. Communications subsystem 2424 serves as an interface for receiving data from and transmitting data to other systems from computer system 2400. For example, communications subsystem 2424 may enable computer system 2400 to establish a communication channel to one or more client devices via the Internet for receiving and sending information from and to the client devices. For example, the communications subsystem may be used to transmit a response to a user regarding the inquiry for a chatbot.

Communications subsystem 2424 may support both wired and/or wireless communication protocols. For example, in certain aspects, communications subsystem 2424 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 2424 can provide wired network connectivity (e.g., Ethernet) in addition to or instead of a wireless interface.

Communications subsystem 2424 can receive and transmit data in various forms. For example, in some aspects, in addition to other forms, communications subsystem 2424 may receive input communications in the form of structured and/or unstructured data feeds 2426, event streams 2428, event updates 2430, and the like. For example, communications subsystem 2424 may be configured to receive (or send) data feeds 2426 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 2424 may be configured to receive data in the form of continuous data streams, which may include event streams 2428 of real-time events and/or event updates 2430, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2424 may also be configured to communicate data from computer system 2400 to other computer systems or networks. The data may be communicated in various different forms such as structured and/or unstructured data feeds 2426, event streams 2428, event updates 2430, and the like to one or more databases that may be in communication with one or more streaming data source computers coupled to computer system 2400.

Computer system 2400 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 2400 depicted in FIG. 24 is intended only as a specific example. Many other configurations having more or fewer components than the system depicted in FIG. 24 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
storing a plurality of user input examples in association with one or more prompt templates, wherein the plurality of user input examples comprise a first user input example comprising a first text portion and a second user input example comprising a second text portion that is different from the first text portion;
receiving, via a user interface, partial text input from a user;
determining that the partial text input is a subset of the first text portion, and based at least in part on determining that the partial text input is a subset of the first text portion, displaying an input template for the partial text input, wherein the input template comprises the first user input example with one or more placeholders in place of one or more variables of the first user input example; wherein an incomplete portion of the input template is graphically distinguished from the partial text input;
receiving completed text input comprising one or more particular variables in place of the one or more placeholders;
selecting a prompt template associated with the first user input example, and generating a prompt based at least in part on the prompt template;
prompting a large language model with the prompt;
receiving a response from the large language model, and causing execution of one or more commands in the response, wherein the execution of the one or more commands modifies one or more data structures based at least in part on the one or more particular variables.

2. The computer-implemented method of claim 1, wherein the first user input example is in the selected one or more prompt templates and included as an example in the prompt.

3. The computer-implemented method of claim 1, wherein the one or more data structures are modified to change a workflow of operations that is executable against a set of data.

4. The computer-implemented method of claim 3, further comprising receiving another user input, generating another prompt comprising the other user input, prompting the large language model with the other prompt, receiving another response from the large language model, and causing execution of the workflow against the set of data based at least in part on the other response.

5. A computer-implemented method comprising:
receiving, via a user interface, text input from a user;
based at least in part on content of the text input, selecting a first prompt template for triggering a first type of application functionality using a first set of one or more command formats, wherein one or more other prompt templates are stored in association with one or more other types of application functionality using one or more other sets of one or more command formats;
generating a prompt based at least in part on the first prompt template, wherein the first prompt template comprises a plurality of examples of using the first set of one or more command formats to generate structured results;
prompting a large language model with the prompt;
receiving a particular structured result from the large language model;
causing display of a predicted outcome of executing, by an application, a particular command of a particular command format from the particular structured result; and
causing execution, by the application, of the particular command of the particular command format from the particular structured result, wherein the execution triggers a change to one or more data structures accessible from a user interface of the application.

6. The computer-implemented method of claim 5, wherein the particular structured result is a JSON object comprising an identified command and one or more parameters of the identified command determined based at least in part on the text input.

7. The computer-implemented method of claim 5, wherein the predicted outcome is displayed as a table of data changes that will occur when the application executes the particular command.

8. The computer-implemented method of claim 5, wherein the change to the one or more data structures changes a workflow of operations that is executable against a set of data.

9. The computer-implemented method of claim 8, further comprising receiving another text input, determining that the other text input is associated with another prompt template;
generating another prompt based at least in part on the other prompt template, wherein the other prompt comprises the other text input;
prompting the large language model with the other prompt; receiving another response from the large language model; and causing execution of the workflow against the set of data based at least in part on the other response.

10. The computer-implemented method of claim 5, wherein the prompt further comprises a context of a user session that identifies one or more objects stored in association with the one or more data structures.

11. A computer-program product comprising one or more non-transitory machine-readable storage media, including stored instructions configured to cause a computing system to perform a set of actions including:
receiving, via a user interface, text input from a user;
based at least in part on content of the text input, selecting a first prompt template for triggering a first type of application functionality using a first set of one or more command formats, wherein one or more other prompt templates are stored in association with one or more other types of application functionality using one or more other sets of one or more command formats;
generating a prompt based at least in part on the first prompt template, wherein the first prompt template comprises a plurality of examples of using the first set of one or more command formats to generate structured results;
prompting a large language model with the prompt;
receiving a particular structured result from the large language model;
causing display of a predicted outcome of executing, by an application, a particular command of a particular command format from the particular structured result; and
causing execution, by the application, of the particular command of the particular command format from the particular structured result, wherein the execution triggers a change to one or more data structures accessible from a user interface of the application.

12. The computer-program product of claim 11, wherein the particular structured result is a JSON object comprising an identified command and one or more parameters of the identified command determined based at least in part on the text input.

13. The computer-program product of claim 11, wherein the predicted outcome is displayed as a table of data changes that will occur when the application executes the particular command.

14. The computer-program product of claim 11, wherein the change to the one or more data structures changes a workflow of operations that is executable against a set of data.

15. The computer-program product of claim 14, wherein the one or more non-transitory machine-readable storage media further include stored instructions configured to cause the computing system to perform a set of actions including:
receiving another text input, determining that the other text input is associated with another prompt template;
generating another prompt based at least in part on the other prompt template, wherein the other prompt comprises the other text input;
prompting the large language model with the other prompt; receiving another response from the large language model; and causing execution of the workflow against the set of data based at least in part on the other response.

16. The computer-program product of claim 11, wherein the prompt further comprises a context of a user session that identifies one or more objects stored in association with the one or more data structures.

17. A system comprising:
one or more processors;
one or more non-transitory computer-readable media storing instructions, which, when executed by the system, cause the system to perform a set of actions including:
receiving, via a user interface, text input from a user;
based at least in part on content of the text input, selecting a first prompt template for triggering a first type of application functionality using a first set of one or more command formats, wherein one or more other prompt templates are stored in association with one or more other types of application functionality using one or more other sets of one or more command formats;
generating a prompt based at least in part on the first prompt template, wherein the first prompt template comprises a plurality of examples of using the first set of one or more command formats to generate structured results;
prompting a large language model with the prompt;
receiving a particular structured result from the large language model;
causing display of a predicted outcome of executing, by an application, a particular command of a particular command format from the particular structured result; and
causing execution, by the application, of the particular command of the particular command format from the particular structured result, wherein the execution triggers a change to one or more data structures accessible from a user interface of the application.

18. The system of claim 17, wherein the change to the one or more data structures changes a workflow of operations that is executable against a set of data.

19. The system of claim 17, wherein the one or more non-transitory machine-readable storage media further include stored instructions configured to cause the computing system to perform a set of actions including:
receiving another text input, determining that the other text input is associated with another prompt template;
generating another prompt based at least in part on the other prompt template, wherein the other prompt comprises the other text input;
prompting the large language model with the other prompt; receiving another response from the large language model; and causing execution of the workflow against the set of data based at least in part on the other response.

20. The system of claim 17, wherein the prompt further comprises a context of a user session that identifies one or more objects stored in association with the one or more data structures.
